(19) United States
(12) Patent Application Publication
(10) Pub. No.: US 2018/0267642 A1
(43) Pub. Date: Sep. 20, 2018

(54) METHOD AND APPARATUS FOR OPERATING FUNCTIONS OF PORTABLE TERMINAL HAVING BENDED DISPLAY

(71) Applicant: Samsung Electronics Co., Ltd., Suwon-si (KR)

(72) Inventors: Youngri KIM, Suwon-si (KR); Ilhwan KIM, Seoul (KR); Dongwoo KIM, Suwon-si (KR); Jaehwan KIM, Suwon-si (KR); Jiyeon YOO, Yongin-si (KR); Juyoun LEE, Seongnam-si (KR); Sangok CHA, Daegu (KR); Siejoon CHO, Seoul (KR)

(21) Appl. No.: 15/985,162

(22) Filed: May 21, 2018

Related U.S. Application Data
(63) Continuation of application No. 13/894,146, filed on May 14, 2013.

(30) Foreign Application Priority Data
May 14, 2012 (KR) 10-2012-0050640

(51) Int. Cl. G06F 3/041; G06F 3/0485; G06F 1/16; G06F 3/0488; G06F 3/0482

(52) U.S. Cl. CPC G06F 3/041; G06F 2203/04803; G06F 2203/04102; G06F 3/0485; G06F 3/0482; G06F 1/1637; G06F 3/0488; G06F 1/1626

(57) ABSTRACT

A portable terminal having a bended display divided into a main region of a front surface and a sub-region of a side of the portable terminal and operating functions of the portable terminal in connection with the main region and the sub-region, and a method of operating the same are provided. The method of operating functions of a portable terminal having a bended display, includes receiving an input of an event, determining a type of the input event, outputting event information, according to an internal event input based on the bended display, through at least one of a main region and a sub-region of the bended display when the input event is the internal event, and outputting event information, according to an external event input from an outside source, through the sub-region of the bended display when the input event is the external event.

### PRIORITY

This application is a continuation application of prior application Ser. No. 13/894,146, filed on May 14, 2013, and was based on and claimed priority under 35 U.S.C. § 119(a) of a Korean patent application filed on May 14, 2012 in the Korean Intellectual Property Office and assigned Serial No. 10-2012-0050640, the disclosure of each of which is incorporated by reference herein in its entirety.

### BACKGROUND OF THE INVENTION

### 1. Field of the Invention

The present invention relates to a display of a portable terminal and a method of operating the same. More particularly, the present invention relates to a portable terminal having a bended display and a method of operating the same.

### 2. Description of the Related Art

In recent years, with advances in digital technology, various mobile communication terminals, such as a Personal Digital Assistant (PDA), an electronic organizer, a smart phone, a tablet Personal Computer (PC), and the like, capable of processing communication and private information have been developed. More particularly, recent mobile terminals have been developed based on a mobile convergence trend including the traditional communication field and other advanced fields. A portable terminal performs various functions, such as a voice call, an image display, a message transmission (such as a Short Message Service (SMS)/a Multimedia Message Service (MMS)), and the like. Moreover, a portable terminal has been developed to serve as a multi-purpose device and thus may include an electronic organizer, a camera, an e-mail transceiver, a broadcasting playback device, a moving image playback device, an Internet browsing device, an electronic commerce device, a music playback device, a schedule management device, a Social Networking Service (SNS) device, a messenger, and the like. In addition, a recent portable terminal performs various services, such as a friend finder, a messenger, a dictionary, and the like.

Recently, a portable terminal having a bended display implemented by coupling a flexible display with the portable terminal as well as the flexible display has been spotlighted. The flexible display is a display which may be freely folded and unfolded. The bended display is a display where a bent shape may be maintained in consideration of a design. More particularly, in recent years, the portable terminal having the bended display has been studied and developed. However, there has been no progress in the development of an outer appearance of a portable terminal having a bended display as well as research for improving function control of the portable terminal using the bended display.

Therefore, there is a need for a portable terminal capable of extending a display region to both of a front surface and a side surface of the portable terminal by implementing a bended display at the portable terminal, and a method of operating functions thereof.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a portable terminal capable of extending a display region to both of a front surface and a side surface of the portable terminal by implementing a bended display at the portable terminal, and a method of operating functions thereof.

Another aspect of the present invention is to provide a portable terminal having a bended display divided into a main region of a front surface and a sub-region of a side of the portable terminal and supporting function control and function display of the portable terminal in connection with the main region and the sub-region, and a method of operating the same.

Another aspect of the present invention is to provide a portable terminal having a bended display capable of allowing a user to approach information associated with a screen displayed on a main region using a sub-region of the bended display and improving usability and operation of a user for controlling functions of the portable terminal using the sub-region, and a method of operating functions thereof.

In accordance with an aspect of the present invention, a method of operating functions of a portable terminal having a bended display is provided. The method includes receiving an input of an event, determining a type of the input event. outputting event information, according to an internal event input based on the bended display, through at least one of a main region and a sub-region of the bended display when the input event is the internal event, and outputting event information, according to an external event input from an outside source, through the sub-region of the bended display when the input event is the external event.

There is also provided a computer readable recording medium for performing the method by a processor.

In accordance with another aspect of the present invention, a portable terminal is provided. The terminal includes a bended display, a memory for storing at least one program, and a controller for executing the at least one program to control an operation of functions of the portable terminal based on the bended display, wherein the at least one program comprises commands for, receiving an input of an event, determining a type of the input event, outputting event information, according to an internal event input based on the bended display, through at least one of a main region and a sub-region of the bended display when the input event is the internal event, and outputting event information, according to an external event input from an outside source, through the sub-region of the bended display when the input event is the external event.

In accordance with still another aspect of the present invention, a computer readable recording medium is provided. The computer readable recording medium includes a program for outputting event information, according to an internal event input based on a bended display, through at least one of a main region and a sub region of the bended display, and for outputting event information, according to an external event input from an outside source, through the sub-region of the bended display.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 and 2 illustrate a portable terminal having a bended display according to an exemplary embodiment of the present invention;

FIG. 3 is a block diagram schematically illustrating a configuration of a portable terminal according to an exemplary embodiment of the present invention;

FIG. 4 illustrates a procedure of operating a sub-region by events generated from a portable terminal according to an exemplary embodiment of the present invention;

FIGS. 5 through 8 illustrate an operation which releases a lock mode using a bended display of a portable terminal according to an exemplary embodiment of the present invention;

FIG. 9 illustrates an operation which provides a charged state using a bended display in a portable terminal according to an exemplary embodiment of the present invention;

FIGS. 10 through 12 illustrate an operation which supports a rapid section motion using a bended display of a portable terminal according to an exemplary embodiment of the present invention;

FIGS. 13 through 18 illustrate an operation which performs a quick command using a bended display of a portable terminal according to an exemplary embodiment of the present invention;

FIGS. 19 through 23 illustrate an operation which supports a clipboard function using a bended display of a portable terminal according to an exemplary embodiment of the present invention;

FIGS. 24 through 26 illustrate an operation which provides information about an attached file using a bended display of a portable terminal according to an exemplary embodiment of the present invention;

FIG. 27 is a diagram illustrating a method of operating functions using a bended display of a portable terminal according to an exemplary embodiment of the present invention;

FIG. 28 is a flowchart illustrating a method of operating functions using a bended display of a portable terminal according to an exemplary embodiment of the present invention; and

FIGS. 29 through 31 illustrate an operation using a bended display of a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention relate to a portable terminal having a bended display and a method of operating functions thereof. Exemplary embodiments of the present invention may divide a bended display into a main region of a front surface and a sub-region of a side of the portable terminal, support display with respect to functions of the portable terminal, and provide an operation of the functions in connection with the main region and the sub-region. The sub-region of the bended display may be used as a function region and a display region. For example, various information, such as pop-up information, attachment information, state information, and control information, corresponding to an application of the main region may be provided through the sub-region. When control of a screen with respect to the main region is required, the sub-region may be operated to control a function with respect to the screen.

The pop-up information may include information for alarming data corresponding to call reception, message reception (e.g., reception of a Short Message Service (SMS)/a Multimedia Message Service (MMS) based message), mail reception, reception of information of a push service, alarm reception of Social Networking Service (SNS), and the like. The pop-up information may be displayed through the sub-region. The attachment information includes information for alarming data attached to a mail, a message, a folder, and the like, and data clipped by the user. The attachment information may be displayed through the sub-region. The state information includes information for alarming a charged state of the portable terminal and an indicator and may be displayed through the sub-region. The control information includes information for providing functions of the portable terminal through the sub-region. Display of the control information through the sub-region may be omitted. However, the control information may be displayed through the sub-region according to a user setting or an application executed through the main region.

According to exemplary embodiments of the present invention, both ends of the portable terminal are bent. Exemplary embodiments of the present invention may include a bended display including a main region of a front surface and a sub-region of a side of the portable terminal which are integrally formed, and a controller for controlling a display with respect to functions of the portable terminal and a function operation in connection with information about the main region and information about the sub-region. The bended display extends to ends of both sides based on a front surface of the portable terminal by way of example, but the bended display may be implemented in various forms. Hereinafter, a configuration of a portable terminal and a method of controlling an operation thereof will be described with reference to the following drawings.

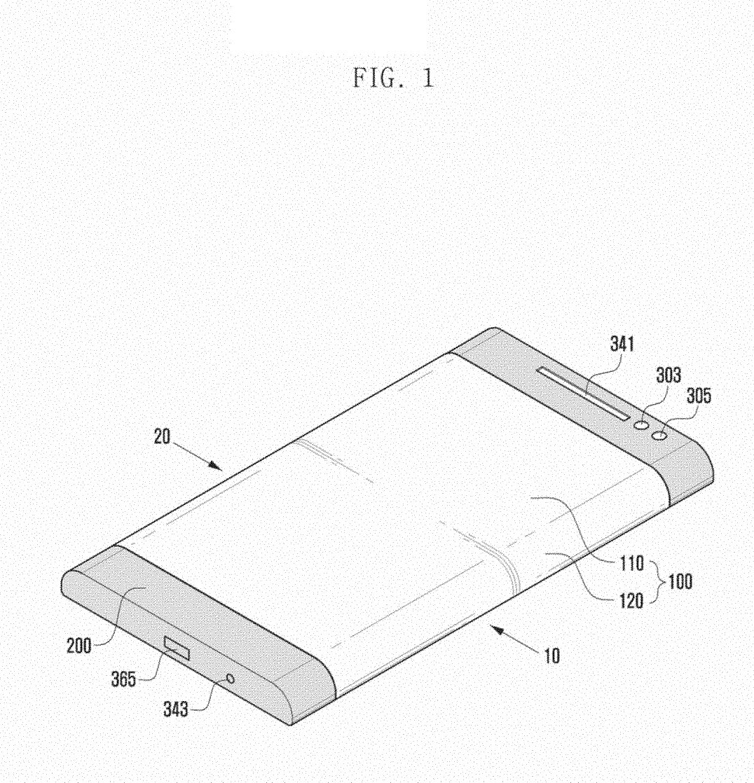

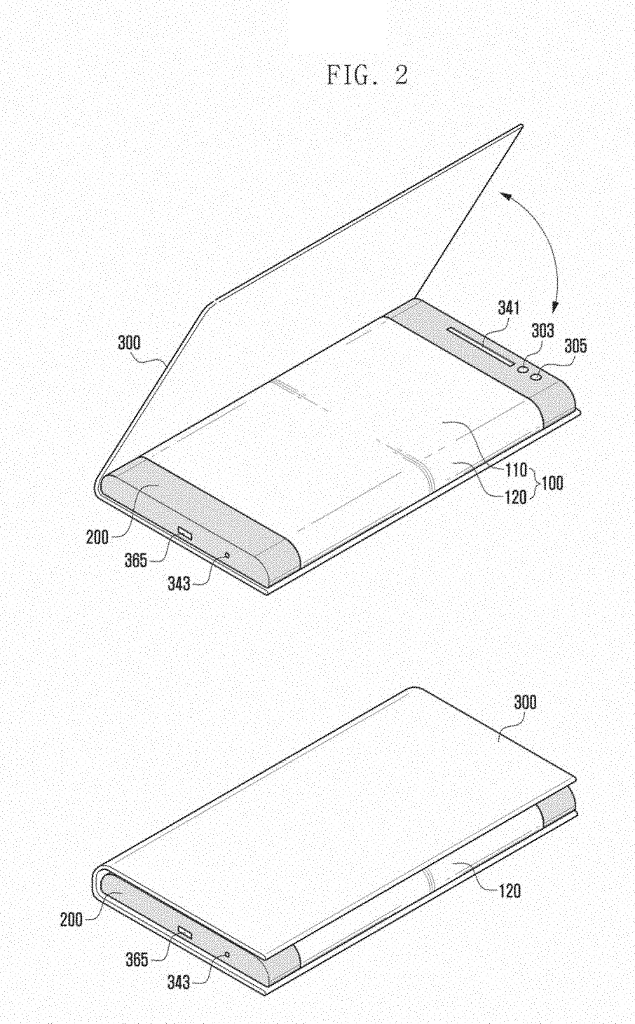

FIGS. 1 and 2 illustrate a portable terminal having a bended display according to an exemplary embodiment of the present invention.

Referring to FIGS. 1 and 2, the portable terminal includes a bended display 100, a body 200 on which the bended display 100 is positioned, and an additional device provided at the body to execute functions of the portable terminal. The additional device may include a speaker 341, a microphone 343, a sensor (e.g., an illumination sensor 303, a front camera module 305, and the like), a connection interface 365 (e.g., a charging port, a data input/output (I/O) port, an audio I/O port, and the like), and a physical button (not shown).

The bended display 100 is bent or rolled without being damaged through a flexible thin substrate like a paper. The bended display 100 is coupled to the body 200 to maintain a bent shape. The portable terminal may be implemented by a display which may be freely folded and unfolded, such as a flexible display, as well as the bended display 100. Since the bended display 100 uses a plastic substrate rather than a general glass substrate, the bended display 100 may be formed using a low temperature manufacturing processor rather than a manufacturing processor of the related art to prevent the substrate from being damaged.

The bended display 100 represents foldable and unfoldable flexibility by substituting a glass substrate covering a liquid crystal by a plastic film in a Liquid Crystal Display (LCD), a Light Emitting Diode (LED), an Organic LED (OLED), an Active Matrix OLED (AMOLED), and the like. The bended display 100 has advantages that it may be thin and lightweight, be robust to impact, be bent, and be manufactured in various shapes.

The bended display 100 has an active matrix screen of a specific size (e.g., 3 inches, 4 inches, 4.65 inches, 4.8 inches, 5 inch, 6.5 inches, 7.7 inches, 8.9 inches, or 10.1 inches, etc.) according to the size of the portable terminal. The bended display 100 may extend to at least one side (e.g., at least one of a left side, a right side, an upper side, and a lower side), be unfolded less than an operable radius of curvature (e.g., radius of curvature of 5 cm, 1 cm, 7.5 mm, 5 mm, 4 mm, etc.), and be coupled with a side of the body 200. Here, a region indicated on a front surface of the bended display 100 refers to a main region 110 of a front surface. A region which extends from the main region 110, is bent to at least one side of the body 200, and is referred to as a sub-region 120 of a side of the portable terminal.

The main region 110 and the sub-region 120 are divided for the purpose of convenient illustration. The main region 110 and the sub-region 120 have at least one end which is bent, and the least one bent end extends to at least one side so that one bended display 100 may be implemented. According to the exemplary implementation, at least one bent end may extend to a rear surface of the portable terminal. Accordingly, a front region having a plane based on a front surface of the portable terminal refers to a main region 110. A region formed at a side of the front surface of the portable terminal refers to a sub-region 120. For example, the main region 110 of a front surface of the portable terminal and the sub-region 120 of a side of the portable terminal are implemented by one integrally configured bended display 100.

In an exemplary portable terminal of the present invention, the bended display 100 is divided into a main region 110 of a front surface and a sub-region 120 of a side of the portable terminal, and the portable terminal may display a screen according to a function operation of the portable terminal and receive a control input for the function operation of the portable terminal. For example, the bended display 100 may support an input and an output, and more particularly support an input and an output by the sub-region 120 simultaneously or individually. An example of an operation according to an input and an output in connection with the main region 110 and the sub-region 120 will be described with reference to the following drawings.

As shown in FIG. 1, the portable terminal may operate functions of the portable terminal in connection with the main region 110 and the sub-region 120 in an open state. As shown in FIG. 2, the portable terminal may operate the functions of the portable terminal using the sub-region 120 in a state that the main region 110 is covered with a case 300. In this case, when the main region 110 is not used because the main region 110 is covered, the main region 110 is outputted with a single color (e.g., black) or power supplied to the main region 110 and the sub-region 120 is separated so that the power supplied to the main region 110 is blocked, thereby omitting a screen display.

Although not shown in FIGS. 1 and 2, a right hand mode and a left hand mode of the portable terminal may be defined using an environment setting or a separate application provided from the portable terminal. The portable terminal may operate the input and the output using only the sub-region 120 of a side of the portable terminal corresponding to a determined mode. For example, when the portable terminal is set to the right hand mode, the input and the output are processed through the sub-region 120 of a right side 10. When the portable terminal is set to the left mode, the input and the output may be processed through the sub-region 120 of a left side 20.

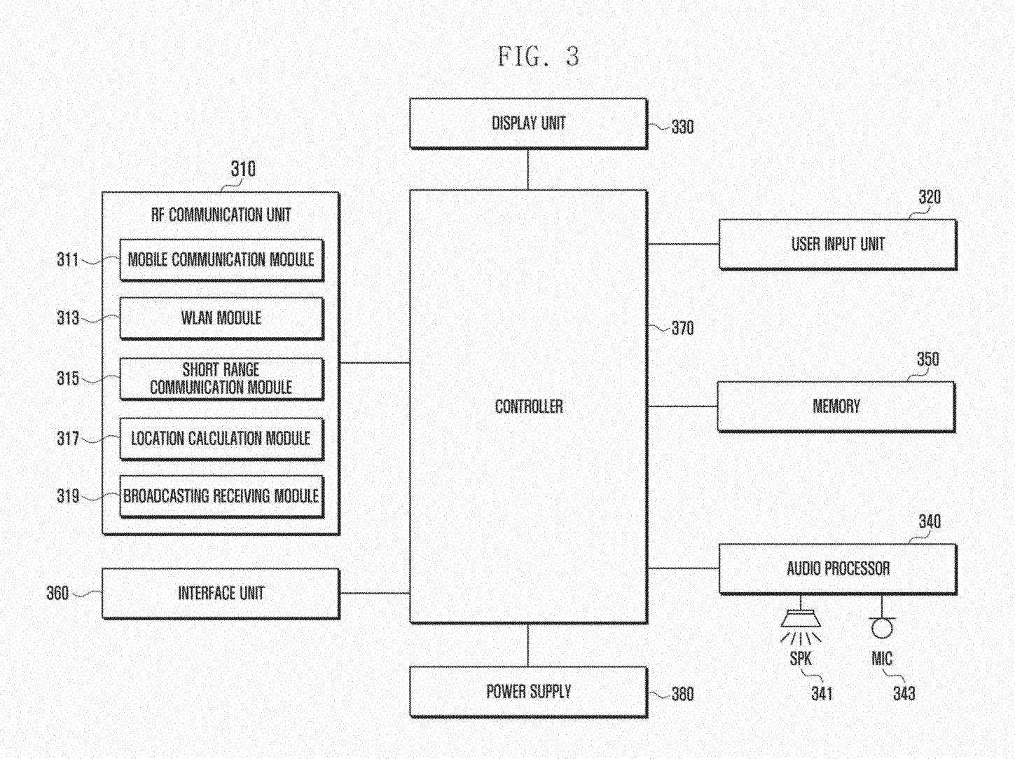

FIG. 3 is a block diagram schematically illustrating a configuration of a portable terminal according to an exemplary embodiment of the present invention.

Referring to FIG. 3, the portable terminal includes a Radio Frequency (RF) communication unit 310, a user input unit 320, a display unit 330, an audio processor 340, a memory 350, an interface unit 360, a controller 370, and a power supply 380. Since constituent elements shown in FIG. 3 are not essential, a portable terminal having more or fewer constituent elements may be implemented.

The RF communication unit 310 may include at least one module capable of performing wireless communication between the portable terminal and a wireless communication system and between the portable terminal and a network in which the portable terminal is located. For example, the RF communication unit 310 may include a mobile communication module 311, a Wireless Local Area Network (WLAN) module 313, a short range communication module 315, a location calculation module 317, and a broadcasting receiving module 319.

The mobile communication module 311 transceives a wireless signal with at least one of a base station, an external terminal, and a server on a mobile communication network. The wireless signal may include various types of data according to the transceiving of a voice call signal, a video call signal, a character/multi-media message, and the like. The mobile communication module 311 may receive an e-mail and an SMS message provided through the network (not shown) or push information pushed through the network.

A wireless Internet module may be a module for access to wireless Internet, and forming a wireless LAN link with another portable terminal, and may be installed at an inside or outside of the portable terminal. Wireless Internet techniques may include a Wireless LAN/Wi-Fi (WLAN), a Wireless broadband (Wibro), a World Interoperability for Microwave Access (Wimax), a High Speed Downlink Packet Access (HSDPA), and the like.

The short range communication module 315 is a module for short range communication. The short range communication techniques may include Bluetooth, a Radio Frequency Identification (RFID), an Infrared Data Association (IrDA), an Ultra Wideband (UWB), ZigBee, and the like.

The location calculation module 317 is a module for acquiring a location of the portable terminal. For example, the location calculation module 317 includes a Global Position System (GPS). The location calculation module 317 may calculate distance information distant from at least three base stations and exact time information, and apply the calculated information to triangulate three-dimensional current location information according to latitude, longitude, and altitude. The location calculation module 317 may continuously receive a current location of the portable terminal from at least three satellites in real time to calculate location information. The location information of the portable terminal may be acquired by various schemes.

The broadcasting receiving module 319 receives a broadcasting signal (e.g., a TeleVision (TV) broadcasting signal, a radio broadcasting signal, a data broadcasting signal, and the like) and/or information (e.g., a broadcasting channel, a broadcasting program or information about a broadcasting service provider, and the like) from an external broadcasting management server through a broadcasting channel (e.g., a satellite channel, a terrestrial channel, and the like).

The user input unit 320 generates input data for controlling an operation of the portable terminal. The user input unit 320 may be configured by a key pad, a dome switch, a touch pad (resistive/capacitive type), and the like.

The display unit 330 displays (outputs) information processed by the portable terminal. For example, when the portable terminal is in a call mode, the display unit 330 displays a User Interface (UI) or a Graphical UI (GUI) associated with a call. When the portable terminal is in an image display mode or a shooting mode, the display unit 330 displays a shot and/or a received image or the UI and the GUI. More particularly, the display unit 330 is implemented by the bended display 100 which is divided into the main region 110 of a front surface and the sub-region 120 of a side of the portable terminal, and supports an input and an output by the bended display 100. For example, the display unit 330 outputs an input received through the UI or the GUI associated with a function operation of the portable terminal by the main region 110 and the sub-region 120. A screen arrangement of the display unit 330 and an example of the screen will be described below.

The display unit 330 may include at least one of an LCD, a Thin Film Transistor-LCD (TFT-LCD), an LED, an OLED, an AMOLED, a flexible display, a bended display 100, and a 3 Dimensional (3D) display. Some of the above displays may be configured as a transparent type or a light transmittance type to look out the exterior therethrough.

According to exemplary embodiments of the present invention, when a touch panel detecting a touch operation forms a layer structure with the display unit 330 (hereinafter referred to as a ‘touch screen’), the display unit 330 may be used as an input device as well as an output device.

The touch panel converts pressure applied to a specific part or variation in capacitance created at the specific part into an electric input signal. The touch panel may detect a touched location and area, and pressure upon a touch. When there is a touch input with respect to the touch panel, corresponding signal(s) are sent to a touch controller (not shown). The touch controller processes the signal(s) and transmits the processed signal(s) to the controller 370. Accordingly, the controller 370 may recognize which region of the display unit 330 is touched.

The audio processor 340 transmits an audio signal from the controller 370 to a speaker 341, and transfers an audio signal, such as a voice, from the microphone 343 to the controller 370. The audio processor 340 convers voice/sound data into an audible sound and outputs the audible sound through the speaker 341 under the control of the controller 370. The audio processor 340 may convert an audio signal, such as a voice, from the microphone 343 into a digital signal, and transfers the display signal to the controller 370.

The speaker 341 may output audio data received from the RF communication unit 310 or stored in the memory 350 in a call mode, a record mode, a voice recognition mode, and a broadcasting receiving mode. The speaker 341 may output a sound signal associated with a function (e.g., a received call signal sound, a received message sound, a music file playback, and the like).

The microphone 343 receives and processes an external sound signal to electric voice data in a call mode, a record mode, and a voice recognition mode. The processed voice data are converted into a transmissible format and the converted data are outputted to a mobile communication base station through a mobile communication module 311. Various noise removal algorithms for removing a noise generated during a procedure of receiving an external sound signal may be implemented in the microphone 343.

The memory 350 may store a program for processing and control of the controller 370, and may temporarily store I/O data (e.g., a telephone directory, a message, an audio, a still image, an electronic book, a moving image, and the like). The memory 350 may store a use frequency (e.g., frequencies in the use of an application, a phone number, a message, multi-media, and the like) and an importance rating. The memory 350 may store data regarding vibration and sound of various patterns output upon a touch input on the touch screen.

The memory 350 may include a storage medium having at least one type of a flash memory type, a hard disk type, a multimedia card micro type, a card type of a memory (for example, a Secure Digital (SD) or an eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a Magnetic RAM (MRAM), a magnetic disc, an optical disc, and the like. The portable terminal may operate in association with a web storage performing a storage function of the memory 350 on the Internet.

The interface unit 360 performs a function of interfacing all external devices connected to the portable terminal with each other. The interface unit 360 may receive data or power from an external device, transfer the data or power to each element in the portable terminal, or transmit data of the voice recognition apparatus to an external device. For example, the interface unit 360 may include a wire/wireless headset port, an external charger port, a wire/wireless data port, a memory card port, a port for connecting a device having an identity module, an audio I/O port, a video I/O port, an earphone port, and the like.

The controller 370 controls an overall operation of the portable terminal. For example, the controller 370 may perform control and processing associated with a voice call, data communication, and a video call. The controller 370 may include a multi-media module for playing multi-media. The multi-media module may be implemented in or separately from the controller 370. More particularly, the controller 370 controls an overall function of the portable terminal using the bended display 100.

The controller 370 provides information corresponding to an operation state of the portable terminal through the sub-region 120 on the bended display 100 divided into the main region 110 and the sub-region 120, controls a function operation of the portable terminal according to a control interaction from the sub-region 120, and displays a corresponding screen on at least one of the main region 110 and the sub-region 120. An exemplary control operation of the controller 370 will be described with reference to the following drawings.

The power supply 380 uses power which is applied from an external power source or an internal power source thereto and supplies power needed to operate each constituent element to each constituent element, under control of the controller 370.

Meanwhile, various exemplary embodiments of the present invention may be implemented in a recording medium which may be read by a computer or a similar device using software, hardware or a combination thereof. According to hardware implementation, various exemplary embodiments of the present invention may be implemented using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and an electric unit for performing the functions. In some cases, variation exemplary methods of the present invention may be implemented by the controller 370. According to the software implementation, exemplary embodiments of procedures and functions according to the specification may be implemented by separate software modules. The software modules may perform at least one function and operation described in the specification.

The portable terminal shown in FIG. 3 may include various devices using an Application Processor (AP), a Graphic Processing Unit (GPU), a Central Processing Unit (CPU), such as various information communication devices, multi-media devices, and application devices thereof. For example, the portable terminal includes devices, such as a tablet Personal Computer (PC), a Smart Phone, a digital camera, a Portable Multimedia Player (PMP), a media player, a portable game terminal, a laptop computer, a Personal Digital Assistant (PDA) as well as mobile communication terminals operating based on respective communication protocols corresponding to various communication systems. The exemplary method of controlling functions of the present invention may be applied to various display devices, such as a Digital Television (TV), a Digital Signage (DS), a Large Format Display (LFD), and the like.

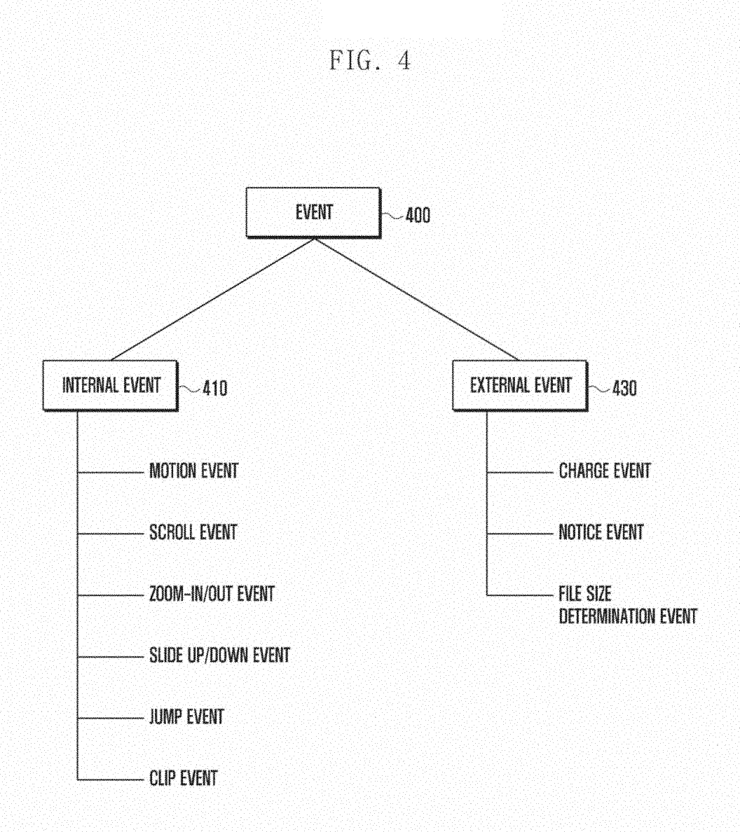

FIG. 4 illustrates a procedure of operating a sub-region by events generated from a portable terminal according to an exemplary embodiment of the present invention.

Referring to FIG. 4, an event 400 for an input or display using a sub-region 120 may be classified into an internal event 410 and an external event 430. The internal event 410 may represent events (e.g., a touch) which the user inputs on one of the main region 110 and the sub-region 120. For example, the internal event 410 may represent events to which a control command input by the user based on the bended display 100. The external event 430 may represent events generated upon reception of information from an outside source (e.g., a base station, another portable terminal, a push server, and the like). As described above, the information may include notice information according to reception of a call, information of a push service, e-mail, alarm of an SNS message, and the like. The portable terminal may output a state of the portable terminal based on the sub-region 120 when detecting the internal event 410 or the external event 430 of the user input by the main region 110 or the sub-region 120.

The internal event 410 may be input through at least one of the main region 110 and the sub-region 120. As shown in FIG. 4, the internal event 410 may be classified into a motion event, a scroll event, a zoom-in/out event, a slide up/down event, a jump event, a clip event, and the like.

The motion event may be input through the sub-region 120, and may represent an event for performing a quick command corresponding to a motion of the user. The motion event may be input to at least one divided quick region to perform a quick command corresponding to the motion of the user. The user may directly execute a specific function of the portable terminal, by a motion event inputting (touching) at least one of quick regions divided in the sub-region 120, similar to playing a guitar.

The scroll event may be input through the sub-region 120, and may represent an event for performing a scroll of a screen displayed on the main region 110. The user may scroll-control a currently viewed screen, such as an electronic book, a contents list (i.e., music, a moving image, and the like), a gallery, and a browser by a scroll event input (e.g., an upward or a downward slide at an optional location of the sub-region 120) using the sub-region 120.

The zoom-in/out event may be input through the sub-region 120, and may represent an event for performing zoom-in or zoom-out of a screen displayed on the main region 110. The user may control the zoom-in or zoom-out with respect to the currently viewed screen, such as an electronic book, a moving image, a gallery, a still image, and a browser by a zoom-in (e.g., an upward slide at an optional location of the sub-region 120) or zoom-out (e.g., a downward slide at the optional location of the sub-region 120) event input using the sub-region 120.

The slide up/down event may be input through the sub-region 120, and may represent an event for adjusting preset values (i.e., display brightness, volume size, and the like). The user may adjust preset values with a setting screen of the portable terminal provided through the main region 110 by a slide up event (e.g., an upward slide at an optional location of the sub-region 120) or a slide down event (e.g., a downward slide at the optional location of the sub-region 120) input using the sub-region 120.

The jump event may be input through the sub-region 120, and may represent an event for performing a section (category) of a screen displayed on the main region 110. The user may control section movement (shortcut) by a jump event to be input to at least one jump item provided from the sub-region 120.

The clip event may be an event which creates a clip item using contents (e.g., images) of the main region 110, and clips the created clip item on the sub-region 120. The clip event may include an event incorporating an item clipped on the sub-region 120 into a screen of the main region 110. For example, the clip event may represent an event for a clipboard function which allows a user to copy contents to be temporarily stored and clip the copied contents on the sub-region 120, and take out the contents from the sub-region 120.

The external event 430 may be input through the RF communication unit 310, the interface unit 360, and the microphone 343. As shown in FIG. 4, the external event 430 may be classified into a charge event, a notice event, and a mass event or a file size determination event.

The charge event may represent an event to which power from the outside source is supplied through the charge port 365. Upon reception of the charge event, that is, when a charger (not shown) is connected through the charge port 365, a charged state of a battery (e.g., a current battery charge level) may be illustrated through the sub-region 120.

The notice event may indicate an event in which notice information is received, such as reception of a call, a message, information of a push service, mail, alarm of an SNS, and the like. Upon reception of the notice event, the portable terminal may represent notice information corresponding to the notice event through the sub-region 120. Here, the notice information according to the notice event is continuously provided until an interaction of the user is input, or is outputted for only a preset time (e.g., 1 second, 3 seconds, 5 seconds, 10 seconds) and display thereof may be omitted.

The file size determination event or mass event may represent an event in which an application having an attached file is executed. When contents (e.g., a mail list, a message list, a product list, and the like) of an application (e.g., a mail application, a message application, a market application, and the like) executed in the main region 110 have an attached file, the portable terminal may determine the event as an input of an attached event. When contents corresponding to an execution application are provided to the main region 110, and a corresponding file size determination event is received, the portable terminal may provide a file size indicator for indicating a size of an attached file having the contents to the sub-region 120.

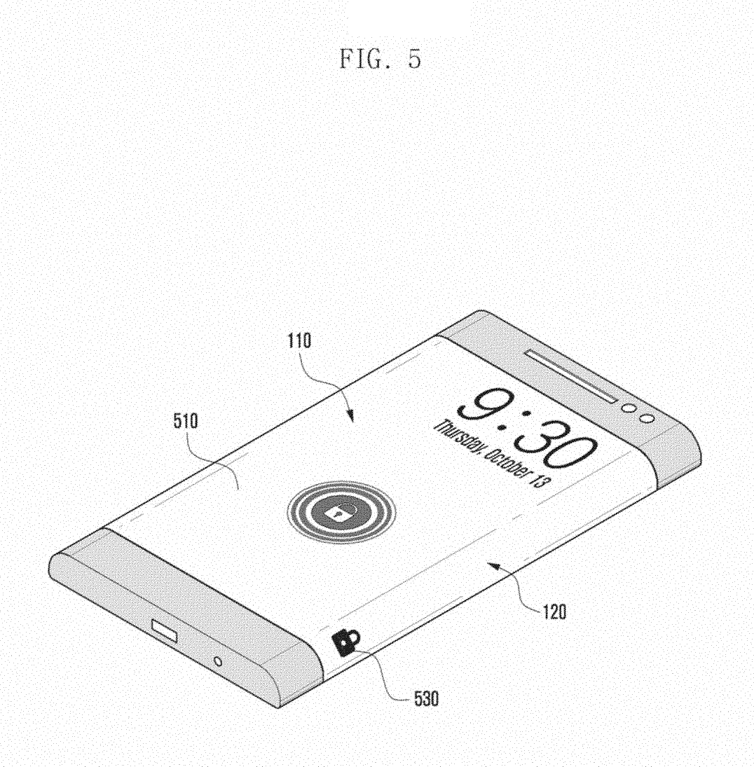

FIGS. 5 through 8 illustrate an operation which releases a lock mode using a bended display of a portable terminal according to an exemplary embodiment of the present invention.

FIGS. 5 through 8 illustrate a state where the portable terminal is functioning in the lock mode, and a lock screen 510 is provided through the main region 110. FIGS. 5 through 8 illustrate an operation which releases the lock mode of the portable terminal using the sub-region 120 while providing a lock release item 530 through the sub-region 120.

Referring to FIG. 5, an exemplary screen of the portable terminal is illustrated wherein the portable terminal is functioning in a lock mode. The lock screen may be provided to the main region 110, and a lock release item 530 may be provided to the sub-region 120. The lock release item 530 is configured in the form of an icon, but may be provided by an icon, a text, or a combination thereof according to an exemplary implementation scheme.

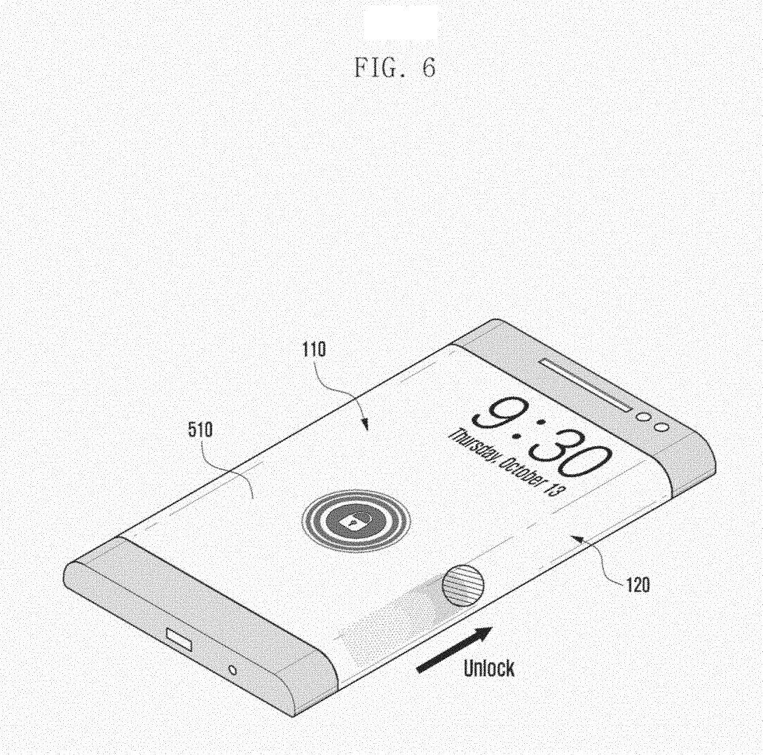

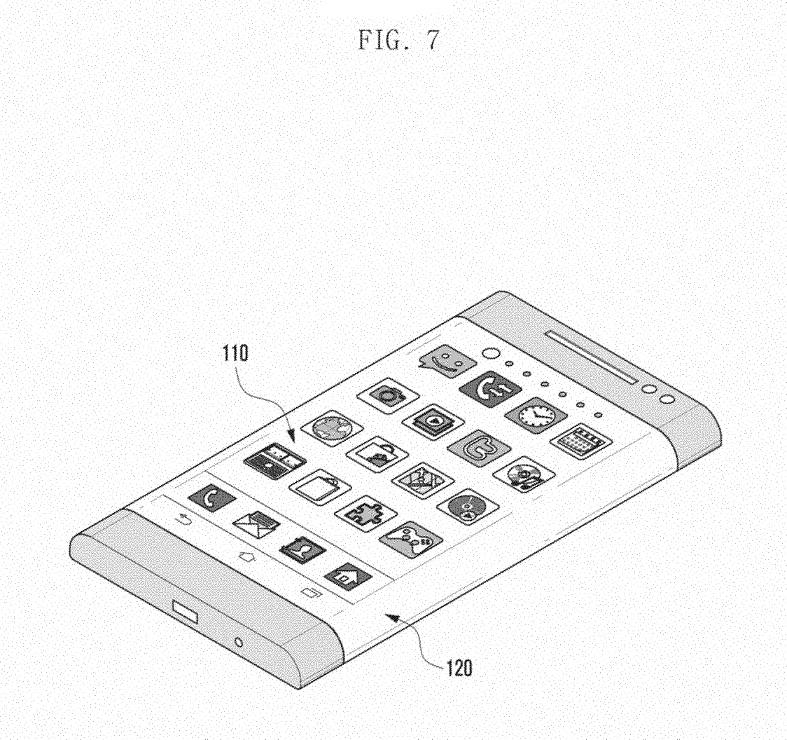

Referring to FIG. 6, the user may input the internal event (e.g., a scroll event) for releasing the lock at the sub-region 120. For example, the user may touch the lock release item 530 in the sub-region 120 or an optional region of the sub-region 120 to move (e.g., a drag, a flick, and the like) the region in one direction for lock release (e.g., an upward direction of the portable terminal). Thereafter, when the internal event is input through the sub-region 120 in a lock mode, the portable terminal displays a screen as illustrated in FIG. 7. For example, a lock screen of the portable terminal, shown in FIG. 5, transitions as illustrated in FIG. 7 according to an input of an internal event (particularly, a scroll event which moves upward for lock release).

Referring to FIG. 7, the portable terminal displays a functioning screen (e.g., a home screen) before entering the lock mode. The portable terminal may transition a screen of the sub-region 120 according to a screen displayed on the main region 110. For example, as shown in FIG. 7, when a home screen is provided through the main region 110, a screen display on the sub-region 120 may be omitted. In this case, as shown in FIG. 7, display of the lock release item 530 shown in FIG. 5 may be omitted. As described above, when the sub-region 120 is not used, the main region 110 is outputted with a single color (e.g., black) or powers of the main region 110 and the sub-region 120 are separated so that power supplied to the main region 110 is blocked, thereby omitting a screen display. As will be described, when a specific screen is displayed on the sub-region 120 according to a screen (that is, a screen of an executed application) displayed on the main region 110, a related screen may be displayed on the sub-region 120.

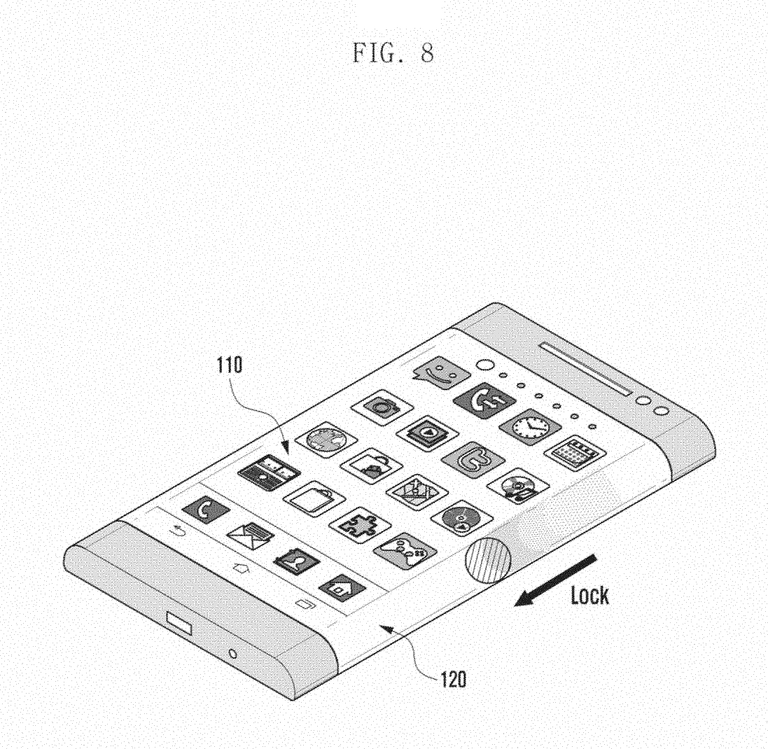

Referring to FIG. 8, the user may input an internal event (e.g., a scroll event) for locking the screen of the portable terminal at the sub-region 120. For example, the user may touch an optional region of the sub region 120 to move the optional region to another direction (e.g., a downward direction of the portable terminal) for locking the screen. Thereafter, as illustrated in FIG. 7, when the internal event is input through the sub-region 120 during an operation of functions of the portable terminal, the portable terminal displays a screen as illustrated in FIG. 5. For example, a screen of the portable terminal shown in FIG. 7 may transition and be displayed as illustrated in FIG. 5 according to input of the internal event (particularly, a scroll event moving downward for locking the screen). The bended display 100 of the portable terminal may be directly turned-off while performing the lock mode without transition of the screen according to a user setting.

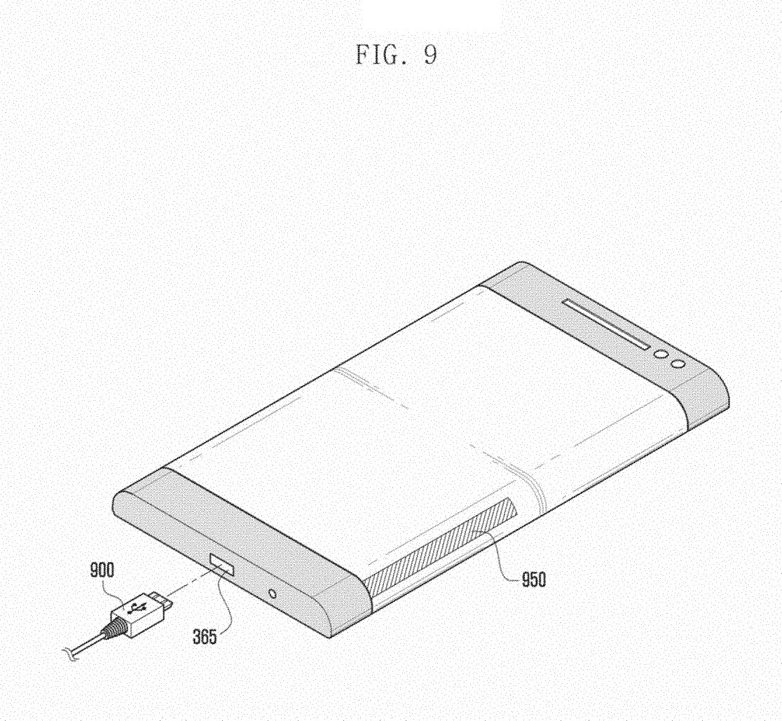

FIG. 9 illustrates an operation which provides a charged state using a bended display in a portable terminal according to an exemplary embodiment of the present invention.

For example, FIG. 9 illustrates an operation in which a charging mode is performed in a state that a charge port 365 is connected to the interface unit 360 of the portable terminal through a connector 900 of the charger.

Referring to FIG. 9, an exemplary screen of a portable terminal illustrates that the portable terminal is functioning in a charging mode. As shown in FIG. 9, the main region 110 is provided in a turned-off state and charging information 950 of a battery (not shown) corresponding to a charged state may be provided to the sub-region 120. The charging information 950 includes visual variation (e.g., a gauge increase of the charging information) with respect to a charged state of the battery and may be provided with an icon of a status bar shape.

As illustrated in FIG. 9, when an external event to which the connector 900 of the charger (not shown) is connected is input to the charge port 365, the portable terminal may display different screens on the main region 110 and the sub-region 120. For example, when the bended display 100 enters a charging mode in a turned-off state, the portable terminal may determine a current battery charge level to represent a corresponding value as charging information 950 of the status bar shape through the sub-region 120 while providing a lock screen as illustrated in FIG. 5 through the main region 110. When a predefined time (e.g., 3 seconds, 5 seconds, 10 seconds, and the like) according to a user setting elapses, the portable terminal may remove screen display of the main region 110, and display only a screen of charging information on the sub-region 120. When the predefined time elapses according to the user setting, the screen display of the sub-region 120 is removed, and charging information 950 may be displayed on the sub-region 120 according to a preset user input (e.g., a touching of the sub-region 120).

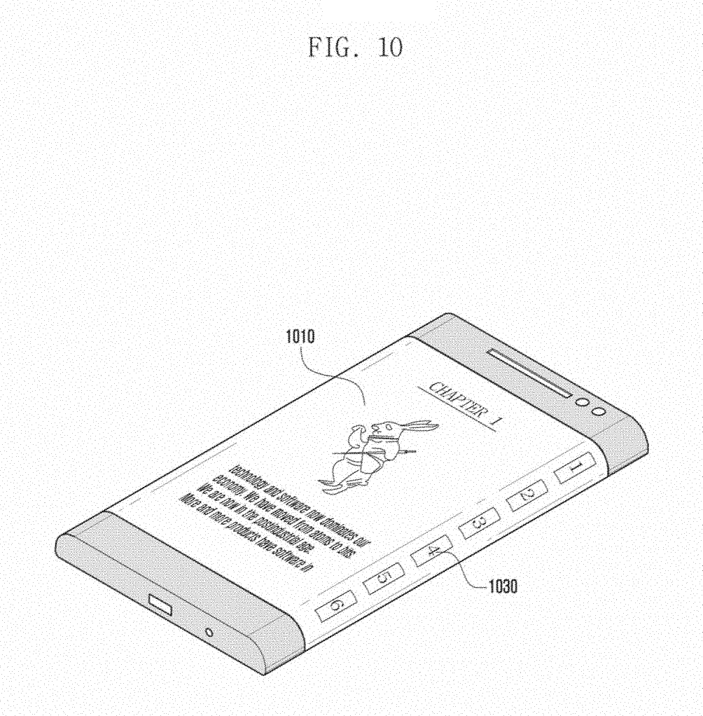

FIGS. 10 through 12 illustrate an operation which supports a rapid section movement using a bended display of a portable terminal according to an exemplary embodiment of the present invention.

Referring to FIGS. 10 through 12, exemplary screens of a portable terminal are illustrated, wherein an application is executed according to a user selection, and corresponding contents are provided through the main region 110 and the sub-region 120. For example, FIGS. 10 through 12 may illustrate examples of each screen when an electronic book application, a photograph application, and a phone book application are executed.

FIG. 10 illustrates a screen of a portable terminal, wherein a user of the portable terminal executes an electronic book application, according to an exemplary embodiment of the present invention.

Referring to FIG. 10, contents 1010 (e.g., an electronic book) corresponding to a user selection may be provided to the main region 110, and a jump item 1030 for controlling a section in the contents 1010 may be provided to the sub-region 120. The jump item 1030 indicates an item for shortcutting (or transitioning) to a specific section (e.g., a chapter, a folder, a category, a page, a bookmark, and the like). The jump item 1030 may be implemented in various patterns, such as a chapter box, a folder box, a page box, a bookmark box, a name quick search box, and the like, according to an execution application. FIG. 10 illustrates that the jump item 1030 is the chapter box, which may be configured according the number of chapters divided in executed contents.

As illustrated in FIG. 10, the user may select one of a plurality of chapter boxes provided on the sub-region 120 as the jump item 1030 during confirming displayed contents 1010. For example, the user may execute an electronic book application, and confirm contents 1010 using the electronic book application. In exemplary embodiments of the present invention, when the electronic book application is executed, the electronic book contents 1010 selected by the user may be provided to the main region 110, and a plurality of chapter boxes by chapters divided according to the contents 1010 may be provided to the sub-region 120 as the jump item 1030. The user may select a chapter box of a chapter to be transitioned to another chapter while confirming contents 1010 displayed on the main region 110. If a jump event for selecting the chapter box is received, the portable terminal confirms a chapter of a chapter box to which the jump event is input, and displays a contents screen of the confirmed chapter. For example, an electronic book screen of the portable terminal shown in FIG. 10 may transition to an electronic book screen of a selected chapter.

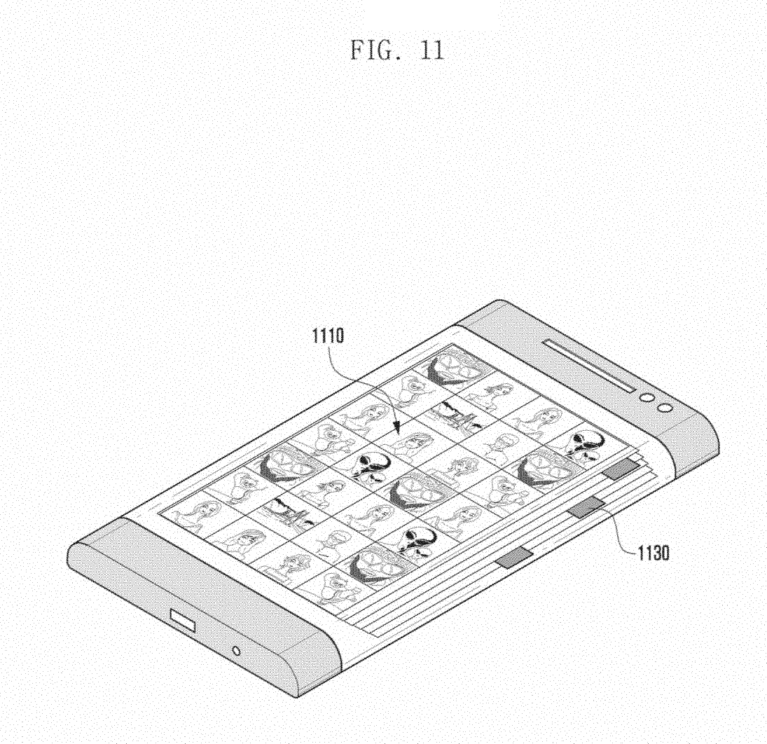

FIG. 11 illustrates a screen of a portable terminal, wherein a user of the portable terminal executes a photograph application, according to an exemplary embodiment of the present invention.

Referring to FIG. 11, contents 1110 (e.g., a photograph list) corresponding to a user selection may be provided to the main region 110, and a jump item 1130 for controlling a section in the contents 1110 may be provided to the sub-region 120. FIG. 11 illustrates that the jump item 1130 is a folder box, which may be configured according to the number of folders configured by dividing photographs by the user.

The user may select one from a plurality of folder boxes provided to the sub-region 120 as a jump item 1130 while confirming contents 1110 displayed on the main region 110. For example, the user executes a photograph application, and confirms contents 1110 (e.g., a photograph list) using the executed photograph application. In exemplary embodiments of the present invention, upon execution of the photograph application, photograph list contents 1110 selected by the user may be provided to the main region 110 and a plurality of folder boxes by dates classified according to the contents 1110 may be provided to the jump item 1130. Folder boxes by dates, places, or users may be provided to the jump item 1130 in the photograph list contents 1110 according to a distinct reference, such as a date and a place of the user. The user may select a folder box of a folder to be transitioned to another folder while confirming contents 1110 displayed on the main region 110. If a jump event for selecting the folder box is received, the portable terminal confirms a folder of a folder box to which the jump event is input, and displays a contents screen of the confirmed folder. For example, a photograph list screen of the portable terminal shown in FIG. 11 may transition to a photograph list screen of the selected folder.

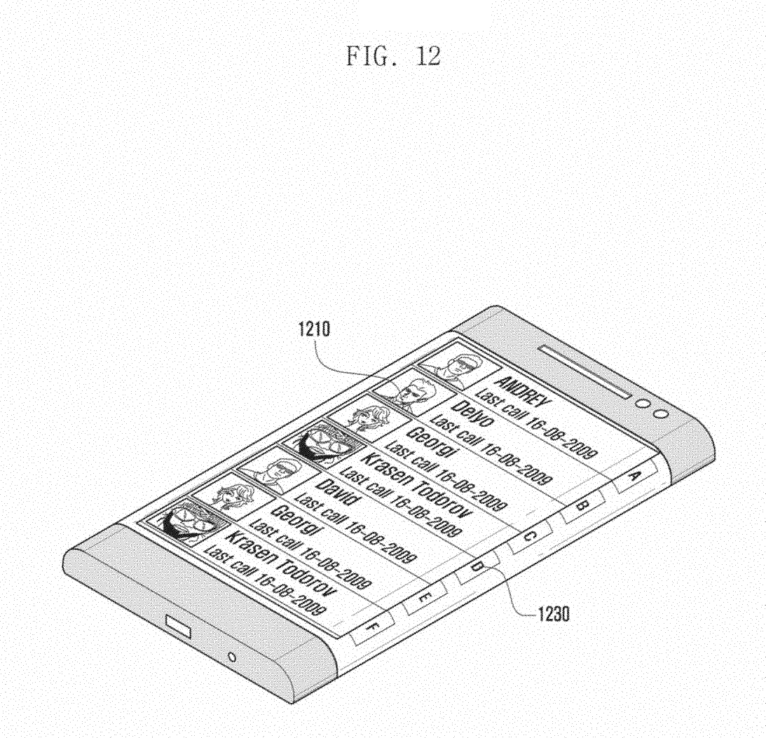

FIG. 12 illustrates a screen of a portable terminal, wherein a user of the portable terminal executes a phone book application, according to an exemplary embodiment of the present invention.

Referring to FIG. 12, contents 1210 (e.g., a phone book list) corresponding to a user selection may be provided to the main region 110, and a jump item 1230 for controlling a section selection in the contents 1210 may be provided to the sub-region 120. FIG. 12 illustrates that the jump item 1230 is a name quick search box. The name quick search box may be configured by phonemes of contact information (e.g., a user name) in a phone book.

The user may select a name quick search box from a plurality of name quick search boxes provided to the sub-region 120 as the jump item 1230 while confirming contents displayed on the main region 110. For example, the user may execute a phone book application, and confirm contents 1210 (e.g., a phone book list) using the executed phone book application. In exemplary embodiments of the present invention, upon execution of the phone book application, phone book list contents 1210 selected by the user may be provided to the main region 110, and a plurality of name quick search boxes by names classified according to the contents 1210 may be provided to the sub-region 120 as the jump item 1230. The user may select a name quick search box of a name group to be transitioned to a name group of another phoneme while confirming contents 1210 displayed on the main region 110. If a jump event for selecting a name quick search box is received, the portable terminal confirms a name group of a name quick search box to which the jump event is input, and displays a contents screen of the confirmed name group. For example, a phone book list screen of the portable terminal shown in FIG. 12 may transition to a phone book list screen of the selected name group.

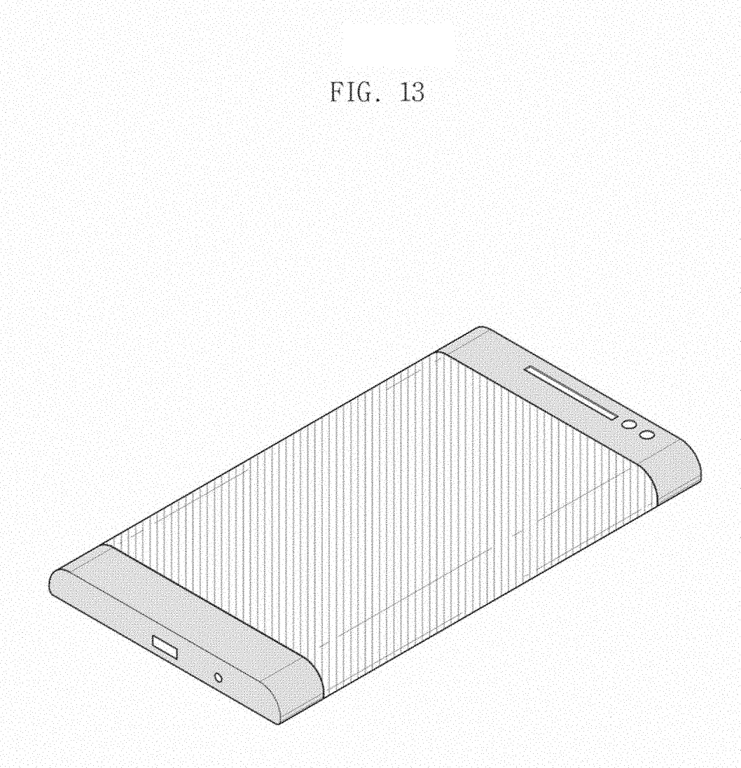

FIGS. 13 through 18 illustrate an operation which performs a quick command using a bended display of a portable terminal according to an exemplary embodiment of the present invention.

FIGS. 13 through 18 illustrate a state that a lock mode functions in a turned-off state of the bended display 100, and a state that a screen is not displayed on the main region 110 and the sub-region 120 according to turning-off of the bended display 100. FIGS. 13 through 18 illustrate an operation which divides a sub-region 120 into a plurality of quick regions to perform a quick command corresponding to motion of the user through the sub-region 120, and performs quick command of the portable terminal according to a user motion event input through divided quick regions.

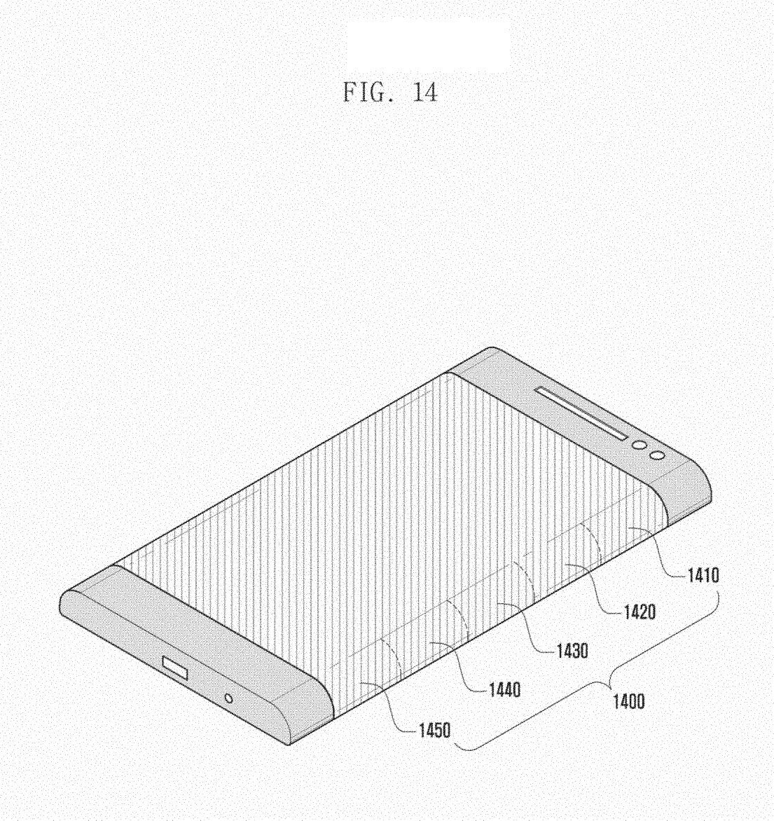

Referring to FIG. 13, it illustrates a case where the bended display 100 of the portable terminal is turned-off. Referring to FIG. 14, the sub-region 120 may be divided into one or more virtual quick regions 1400 to perform the quick command. FIGS. 13 through 18 illustrate that the quick region 1400 is divided into five regions, but may be variously implemented according to a user setting. A command value for performing a quick command of the user may be previously set using an individual region of the quick region 1400 or a plurality of regions in which at least two regions are combined.

For example, the quick region 1400 is divided into five regions including a first quick region 1410 through a fifth quick region 1450. Different shortcut functions may be set to singe quick regions in such a way that a previous application, a next application, an application A (e.g., an internet application), an application B (e.g., a message application), and an application C (e.g., a photograph application) are set to a first quick region 1410, a second quick region 1420, a third quick region 1430, a fourth quick region 1440, and a fifth quick region 1450, respectively.

Different shortcut functions may be set according to a combination of a plurality of quick regions including a procedure of configuring a home screen movement by combining the fourth quick region 1440 with the second quick region 1420 as one group, a procedure of configuring call transmission (e.g., a call transmission based on contact information of a user A) by combining the third quick region 1430 with the first quick region 1410 as one group, a procedure of configuring a call transmission (e.g., a call transmission based on contact information of a user B) by combining the fourth quick region 1440 with the first quick region 1410 as one group, a procedure of configuring an SNS by combining the fifth quick region 1450 with the first quick region 1410 as one group, and a procedure of configuring power off of the portable terminal by combining the third quick region 1430, the fourth quick region 1440, and the fifth quick region 1450 as one group. Functions with classified quick region 1400 may be set and operated to a single quick region like the former, be set and operated to a combination of at least two quick regions like the latter, the former and the latter may be simultaneously operated, which may be variously configured according to a user setting.

Accordingly, the user may directly execute a corresponding function set to a quick region to which a motion event is input by inputting a motion event for selecting at least one quick region 1400 of the sub-region 120 while using the portable terminal. The motion event may be classified into a single touch based input selecting one from the quick regions 1400 and a multi-touch based input selecting at least two from the quick regions 1400 within a preset error range (e.g., 1 second, 2 seconds, 3 seconds, and the like). FIGS. 14 through 18 illustrate an operation which performs a quick command of the portable terminal using the sub-region 120 according to a multi-touch based motion event.

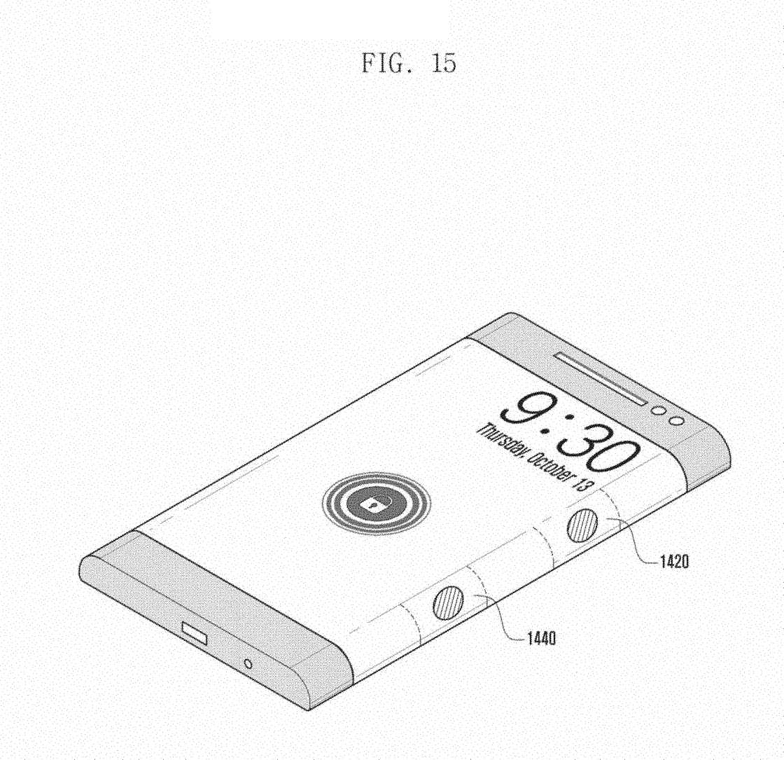

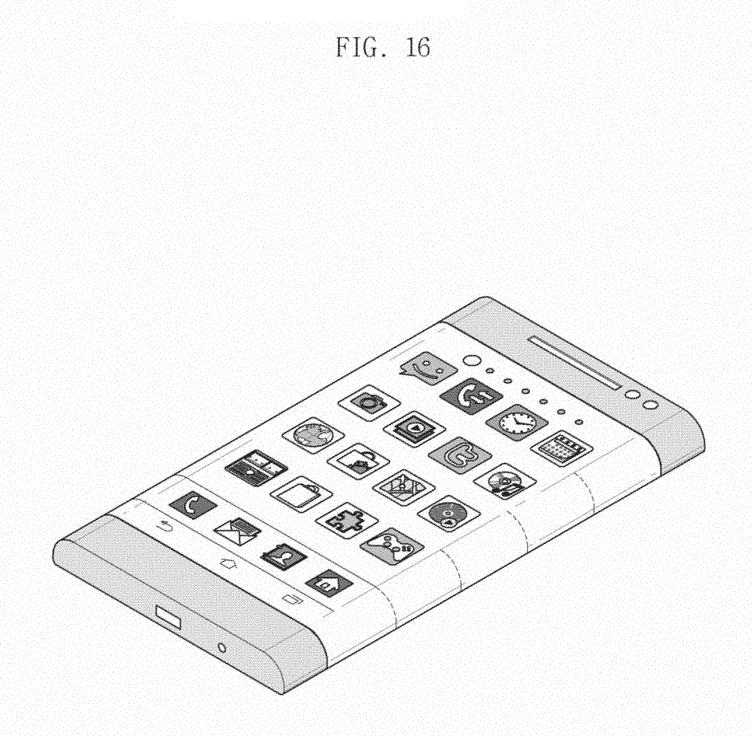

In a state that the bended display 100 is turned-off, as illustrated in FIG. 14, or the lock screen is displayed, the user may input a multi-touch based motion event for selecting the second quick region 1420 and the fourth quick region 1440. For example, the user may input a motion event for selecting the second quick region 1420 and the fourth quick region 1440 using two fingers. The motion event may be set to be operated when it is input for a preset time (e.g., three seconds, five seconds, and the like) or greater. It is assumed that a quick command by a combination of the second quick region 1420 and the fourth quick region 1440 is home screen movement. Thereafter, if the motion event is input through the second quick region 1420 and the fourth quick region 1440 in a state that the bended display 100 is turned-off (FIG. 14) or a lock screen is displayed, the portable terminal displays a screen as illustrated in FIG. 16. For example, the turned-off screen of the portable terminal shown in FIG. 14 or a lock screen of the portable terminal shown in FIG. 15 transitions as illustrated in FIG. 16 according to an input of the motion event.

Referring to FIG. 16, the portable terminal displays a home screen set to the motion event. The portable terminal may configure and represent a screen of the sub-region 120 according to a screen (that is, a home screen) displayed on the main region 110 upon transition of the screen. For example, as shown in FIG. 16, when the home screen is provided through the main region 110, screen display on the sub-region 120 may be omitted.

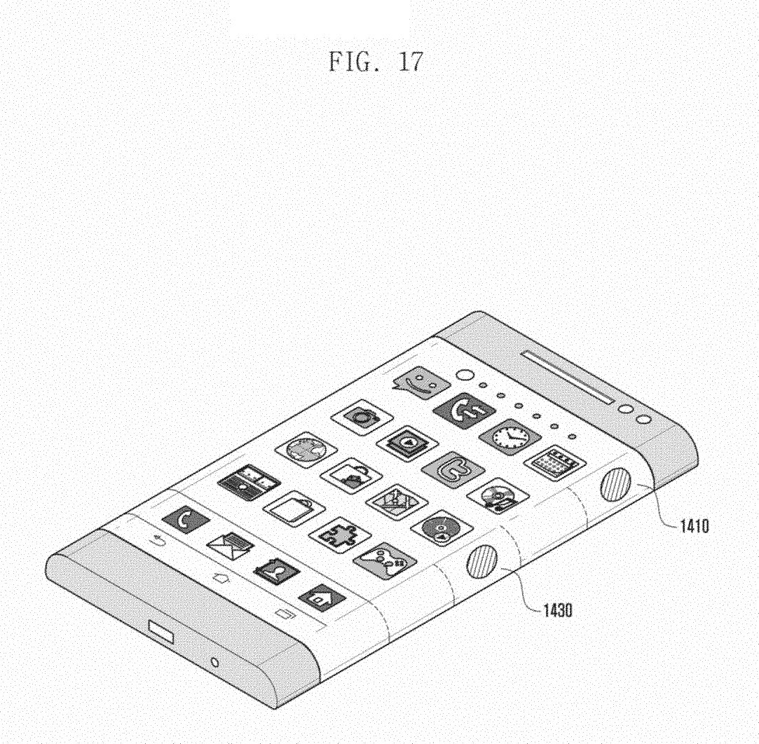

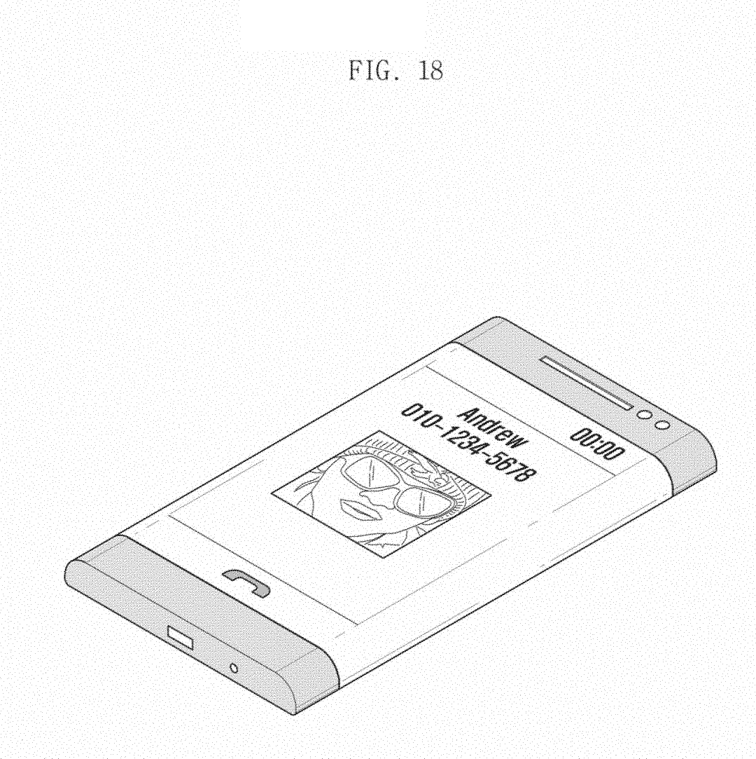

Referring to FIG. 17, the user may input a multi-touch based motion event for selecting the first quick region 1410 and the third quick region 1430 of the sub-region 120. For example, the user may input a motion event for selecting the first quick region 1410 and the third quick region 1430 using two fingers. Here, it is assumed that a quick command by a combination of the first quick region 1410 and the third quick region 1430 is a call transmission based on contact information of the user A. Thereafter, if the motion event is input through the first quick region 1410 and the third quick region 1430 in a state that the home screen is displayed, the portable terminal displays a screen as illustrated in FIG. 18. For example, the home screen of the portable terminal shown in FIG. 16 transitions as illustrated in FIG. 18 according to the motion event.

Referring to FIG. 18, the portable terminal performs call transmission using contact information of the user A set to the motion event with respect to the first quick region 1410 and the third quick region 1430, and displays a corresponding call transmission screen. In the portable terminal, upon transition of the screen, screen display on the sub-region 120 may be omitted according to a screen (that is, a call transmission screen) displayed on the main region 110. In exemplary embodiments of the present invention, upon performing the call transmission function, input of the motion event on the sub-region 120 may be blocked. For example, since the user grasps the portable terminal during a call transmission, the input of the motion event with respect to the quick regions 1400 of the sub-region 120 is blocked to prevent an erroneous operation according to detection of a motion event on the sub-region 120. When the call transmission function is terminated, the portable terminal may again activate the input of the motion event by quick regions 1400 of the sub-region 120.

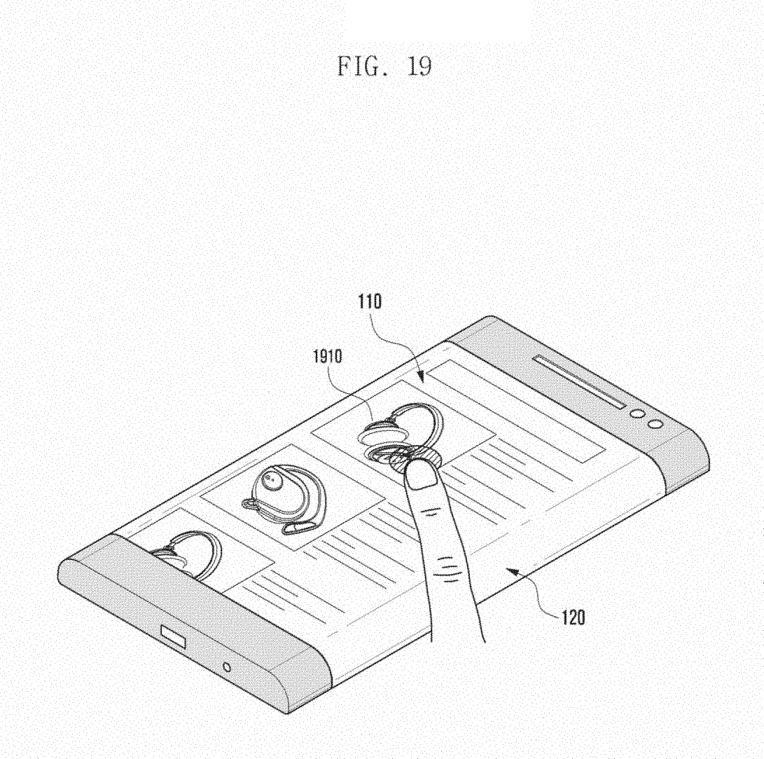

FIGS. 19 through 23 illustrate an operation which supports a clipboard function using a bended display of a portable terminal according to an exemplary embodiment of the present invention.

Referring to FIGS. 19 through 23, a screen of the portable terminal illustrates that the portable terminal executes an application according to a user selection and corresponding contents are provided through the main region 110. For example, FIG. 19 illustrates a screen of a portable terminal, wherein a user of the portable terminal executes an Internet application.

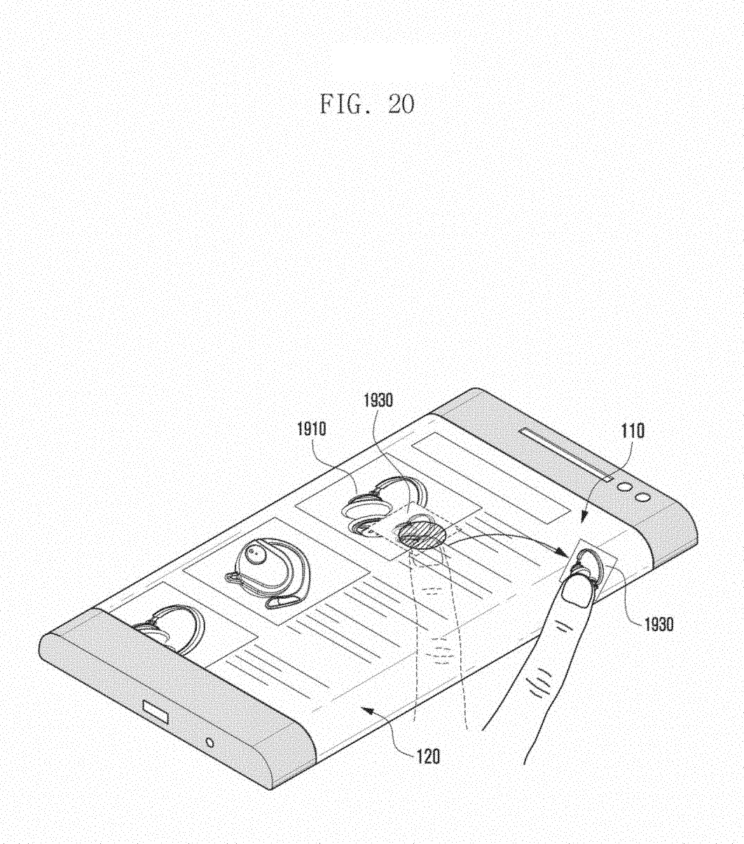

Referring to FIG. 19, contents (e.g., a web screen) corresponding to the user selection may be provided to the main region 110. The user may select an object 1910 (e.g., an image, a text, and the like) of contents (e.g., a web screen) displayed on the main region 110 while confirming the contents displayed on the main region 110, and input a clip event for moving the selected object 1910 to the sub-region 120, as illustrated in FIG. 20. For example, the user may input a clip event for clipping the object of the main region 110.

Referring to FIG. 20, the portable terminal may create a virtual clip item 1930 having a shape corresponding to the object selected from the main region 110 and represent the virtual clip item 1930 at a user input location. As the user input is moved to the sub-region 120, the portable terminal may move the clip item 1930 corresponding to the user input motion and represent the moved clip item 1930.

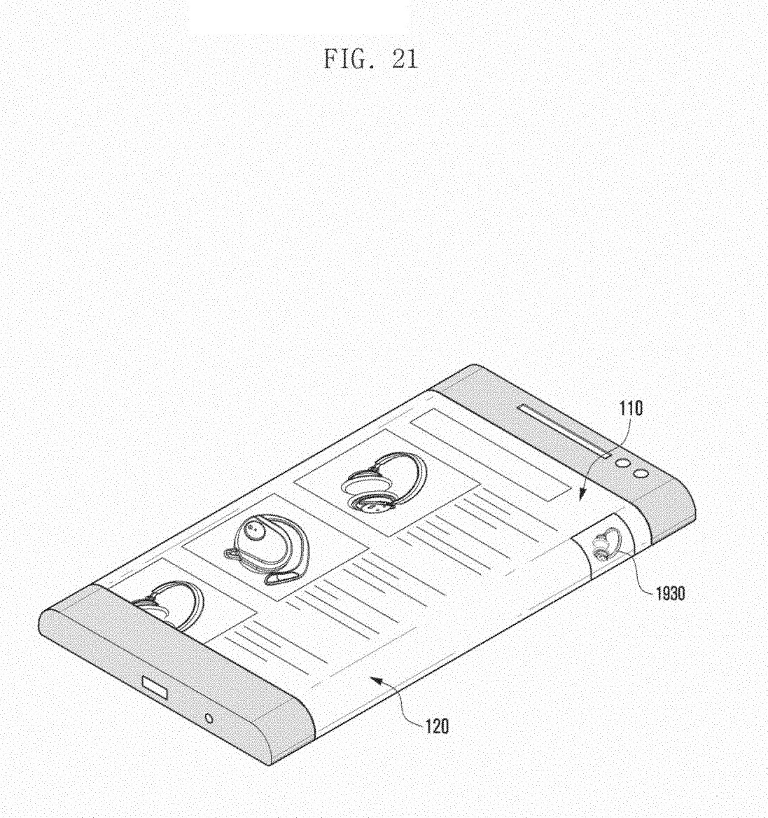

When the user input is located on the sub-region 120, as shown in FIG. 21, the portable terminal may clip the clip item 1930 on a region in which the user input of the sub-region 120 is located and represent the clip item 1930. When the clip item 1930 is clipped on the sub-region 120, the portable terminal may copy the object corresponding to the clip item 1930 and store the copied object in a clipboard region as clip data.

Referring to FIG. 21, in a state that the clip item 1930 is clipped on the sub-region 120, the user may transition the screen of the main region 110. For example, the user may execute a chatting application and display a corresponding screen through the main region 110.

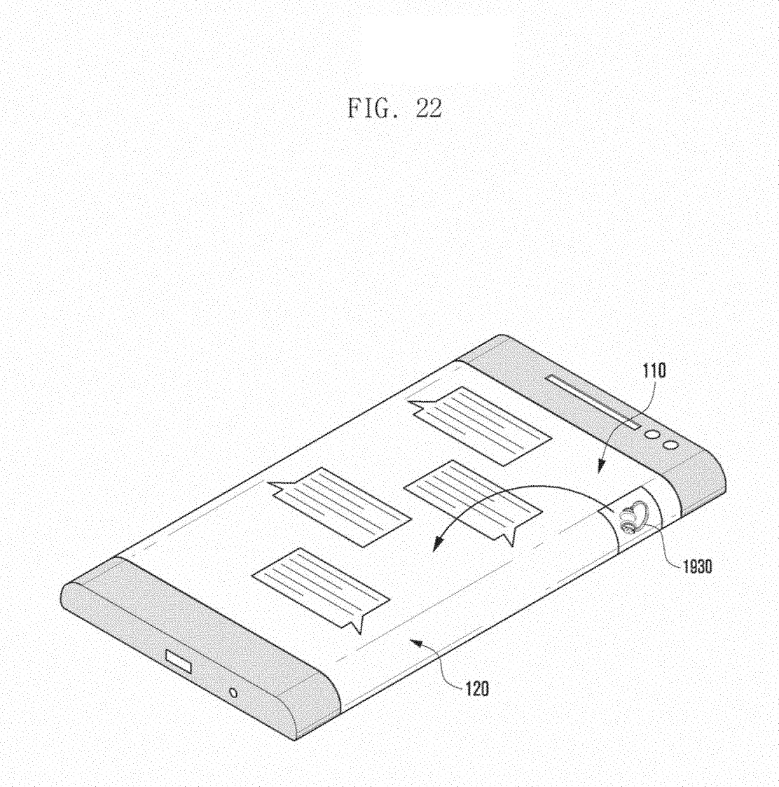

FIG. 22 illustrates a screen of a portable terminal when a user executes a chatting application, according to an exemplary embodiment of the present invention.

Referring to FIG. 22, a chatting screen of the chatting application corresponding to a user selection may be provided to the main region 110, and the clip item 1930 clipped corresponding to the clip event of the user may be provided to the sub-region 120.

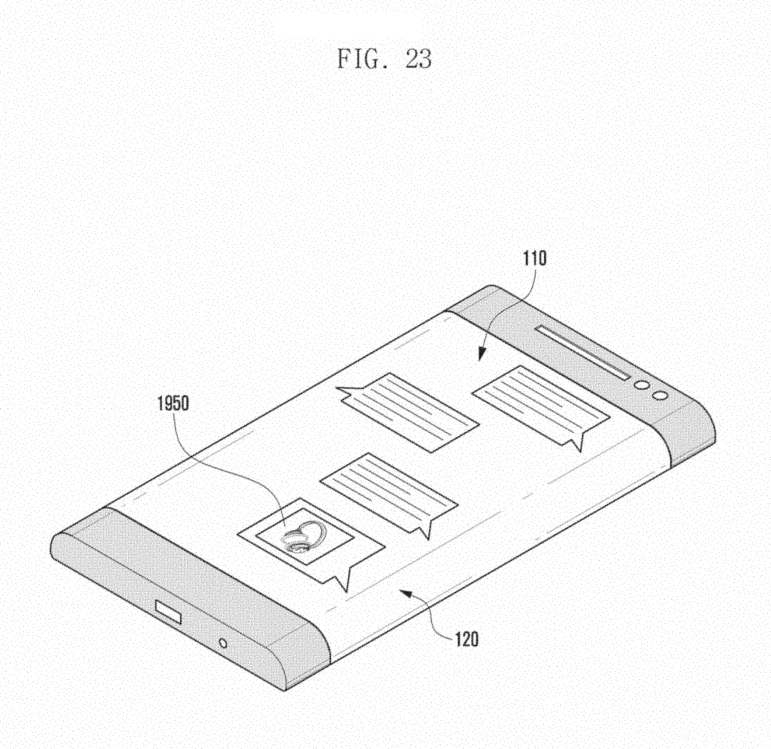

As shown in FIG. 22, the user may select the clip item 1930 displayed on the sub-region 120. For example, the user may execute the chatting application, and may select the clip item 1930 and incorporate it into the chatting application. As shown in FIG. 22, the user may move the clip item 1930 selected from the sub-region 120 to the main region 110, and release the user input. For example, the user may select the clip item 1930 and incorporate (e.g., a drag and drop) the selected clip item into the main region 110. When receiving the clip event for moving the clip item 1930, the portable terminal removes the clip item 1930 from the sub-region 120, and displays a chatting screen into which the clip item 1930 is incorporated. The chatting screen of the portable terminal shown in FIG. 22 may transition to a chatting screen to which clip data 1950 corresponding to the clip item 1930 is added, as illustrated in FIG. 23. If an input of the clip event in which the clip item 1930 of the sub-region 120 is incorporated into an application execution screen of the main region 110 is received, the portable terminal may call clip data stored in a clipboard region corresponding to the clip item 1930 and incorporate the clip data into the execution screen.

As described above, the user copies an object and clips the copied object in the sub-region 120. If the user wishes, the user may support a clipboard function which takes the clip item from the sub-region 120 and incorporates the clip item into another execution application. Although FIGS. 19 through 23 illustrate a case where one clip item 1930 is clipped by way of example, a plurality of clip items 1930 may be clipped to the sub-region 120 and provided according to a user input.

Referring to FIG. 23, the clip item 1930 is removed from the sub-region 120 when the clip item 1930 is incorporated into the main region 110, but the clip item 1930 of the sub-region 120 may continuously maintain a clip state according to a user setting.

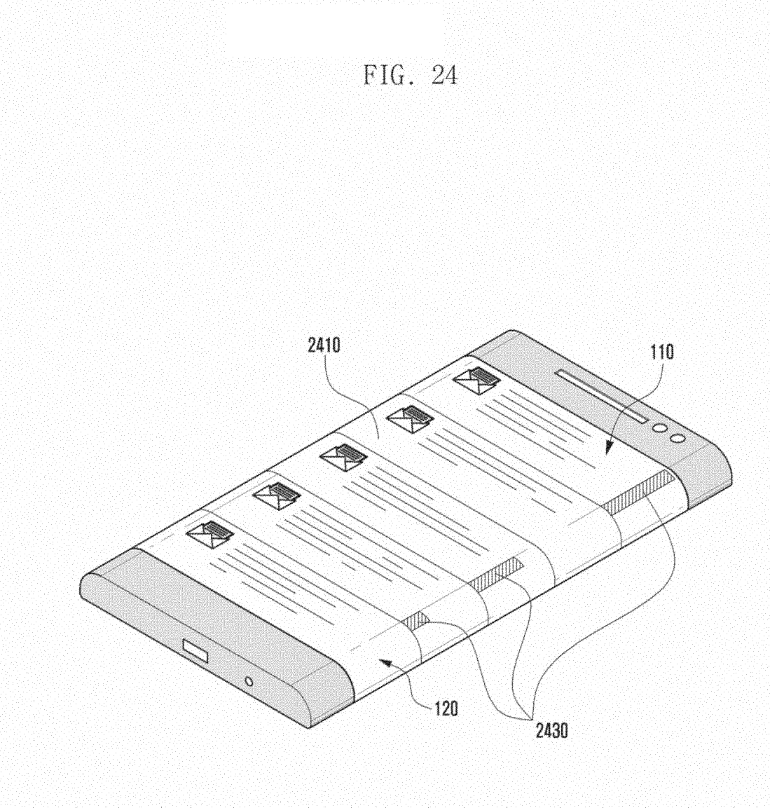

FIGS. 24 through 26 illustrate an operation which provides information about an attached file using a bended display of a portable terminal according to an exemplary embodiment of the present invention.

Referring to FIGS. 24 through 26, a screen of the portable terminal are illustrated when the portable terminal executes an application according to a user selection, and corresponding contents are provided through the main region 110 and the sub-region 120, respectively. For example, FIGS. 24 through 26 illustrate examples of each screen when an application having an attached file, such as a main application, a message application, a market application, and the like, is executed. More particularly, in cases of FIGS. 24 through 26, contents may be provided to the main region 110, and file size indicators 2430, 2530, and 2630, respectively, for indicating a size of an attached file included in the contents may be provided to the sub-region 120. The file size indicators indicate a size of a file attached in the contents and the number of pages in the contents.

FIG. 24 illustrates a screen of a portable terminal when a user of the portable terminal executes a mail application, according to an exemplary embodiment of the present invention.

Referring to FIG. 24, contents 2410 (e.g., a mail list) corresponding to the user selection may be provided to the main region 110, and file size indicators 2430 for indicating a size of an attached file included in the contents 2410 (particularly, each mail item in the mail list) may be provided to the sub-region 120.

As illustrated in FIG. 24, when contents 2410 of a mail list are displayed on the main region 110, the portable terminal may determine respective mail items in the mail list to identify a mail item having an attached file. The portable terminal may determine a size of an attached file of mail items having the attached file and represent the file size indicators 2430 in proportion to the determined size of the attached file on the sub-region 120. For example, the portable terminal may determine a size of the attached file according to a preset reference range (e.g., greater than 0 and less than 1M, equal to or greater than 1M and less than 3M, equal to or greater than 3M and less than 5M, equal to or greater than 5M and less than 10M, and the like), and represent the size of the attached file with respect to the determined reference range on the sub-region 120, as illustrated by the file size indicators 2430. When the mail list of the main region 110 is scrolled, the portable terminal may further scroll the sub-region 120 in response to the scrolling of the mail list. For example, a screen of the portable terminal shown in FIG. 24 may transition to a screen to which the mail list is moved corresponding to the scroll event.

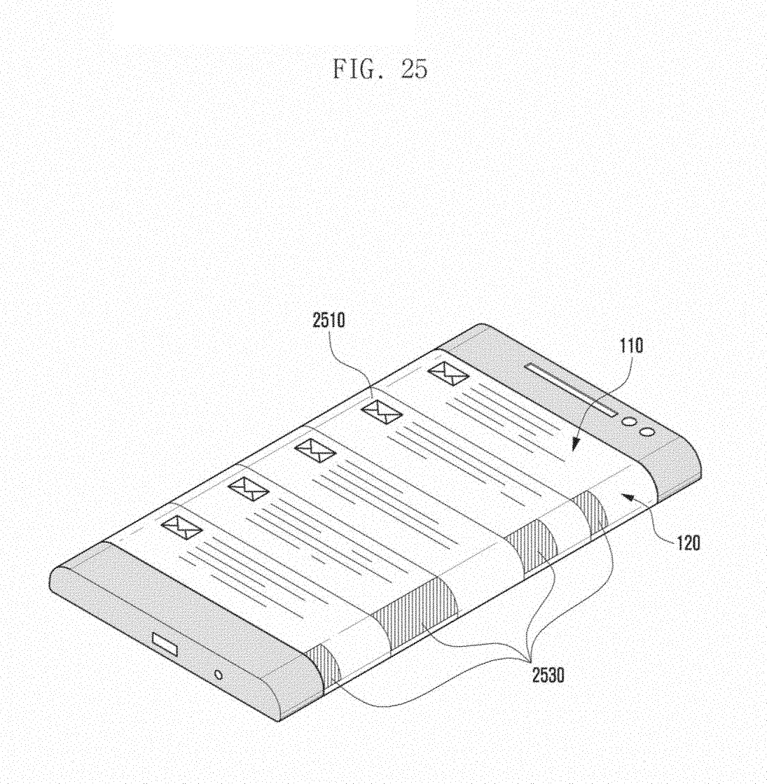

FIG. 25 illustrates a screen of a portable terminal when a user of the portable terminal executes a message application, according to an exemplary embodiment of the present invention.

Referring to FIG. 25, contents 2510 (e.g., a message list) corresponding to a user selection may be provided to the main region 110, and file size indicators 2530 for indicating a size of an attached file included in the contents 2510 (particularly, each message item in the message list) may be provided to the sub-region 120.

As illustrated in FIG. 25, when the portable terminal displays contents 2510 of the message list on the main region 110, the portable terminal may determine respective message items in the message list to identify a message item having an attached file. The portable terminal may determine the size of an attached file of message items having the attached file, and represent the size of the attached file on the sub-region 120, as illustrated by the file size indicators 2530. For example, the portable terminal may determine a size of the attached file according to a preset reference range (e.g., greater than 0 and less than 1M, equal to or greater than 1M and less than 3M, equal to or greater than 3M and less than 5M, equal to or greater than 5M and less than 10M, and the like), and represent the size of the attached file with respect to the determined reference range on the sub-region 120, as illustrated by the file size indicators 2530. When the mail list of the main region 110 is scrolled, the portable terminal may further scroll the sub-region 120 in response to the scrolling of the mail list. For example, a screen of the portable terminal shown in FIG. 25 may transition to a screen to which the mail list is moved corresponding to the scroll event.

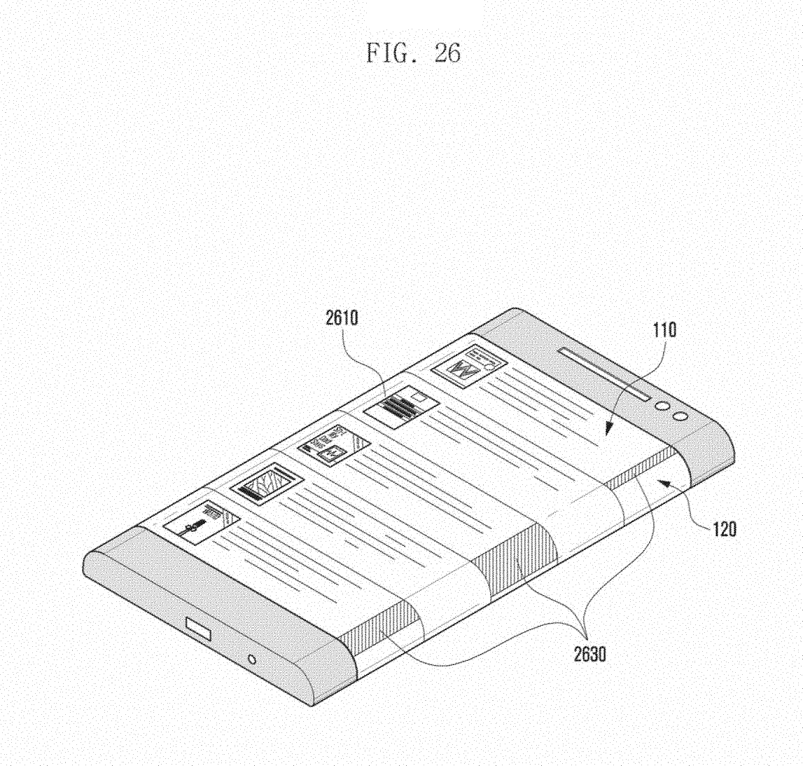

FIG. 26 illustrates a screen of a portable terminal when a user of the portable terminal executes a market application, according to an exemplary embodiment of the present invention.

Referring to FIG. 26, contents 2610 (e.g., a product list (i.e., an App, an electronic book, and the like)) corresponding to the user selection may be provided to the main region 110, and file size indicators 2630 for indicating a size of an attached file included in the contents 2610 (particularly, each product item in a produce list) may be provided to the sub-region 120. FIG. 26 illustrates a case where the product list according to the contents 2610 is an electronic book list by way of example.

As illustrated in FIG. 26, when displaying contents 2610 of a product (i.e., an electronic book) list on the main region 110, the portable terminal may determine the size (number) of pages of respective electronic book items in the product list, and represent the size of the attached file with respect to the determined size of the pages on the sub-region 120, as illustrated by the file size indicators 2630. For example, the portable terminal may determine the size of the attached file according to a preset reference range (e.g., less than 50 pages, equal to or greater than 50 pages and less than 100 pages, equal to or greater than 100 pages and less than 200 pages, equal to or greater than 200 pages, and the like), and represent the size of the attached file with respect to the determined reference range on the sub-region 120, as illustrated by the file size indicators 2630. When the product list of the main region 110 is scrolled, the portable terminal may further scroll the sub-region 120 in response to the scrolling of the product list. For example, a screen of the portable terminal shown in FIG. 25 may transition to a screen to which the product list is moved corresponding to the scroll event.

Meanwhile, as shown in FIGS. 24 through 26, the file size indicators 2430, 2530, and 2630 may be implemented in various forms according to a user setting. For example, the file size indicators 2430 of FIG. 24 may be provided in a divided region by items in a bar pattern using only a part of the sub-region 120 at a boundary between the main region 110 and the sub-region 120, and the extent thereof may be represented as a length in proportion to the size of the attached file. In this case, a small bar may have a size when the portable terminal is viewed from both of a front surface and a side surface. The file size indicators 2530 of FIG. 25 may be provided to regions divided by items in a bar pattern using a total of the sub-region 120, and the extent thereof may be indicated as a length in proportion to the size of the attached file. The file size indicators 2630 of FIG. 26 may be provided to regions divided by items in a bar pattern using a total of the sub-region 120, and the extent thereof may be represented as a length in proportion to the size of the attached file. The file size indicators 2430, 2530, and 2630 may be provided in one pattern or a combined pattern according to a user setting, and be separately provided by applications.

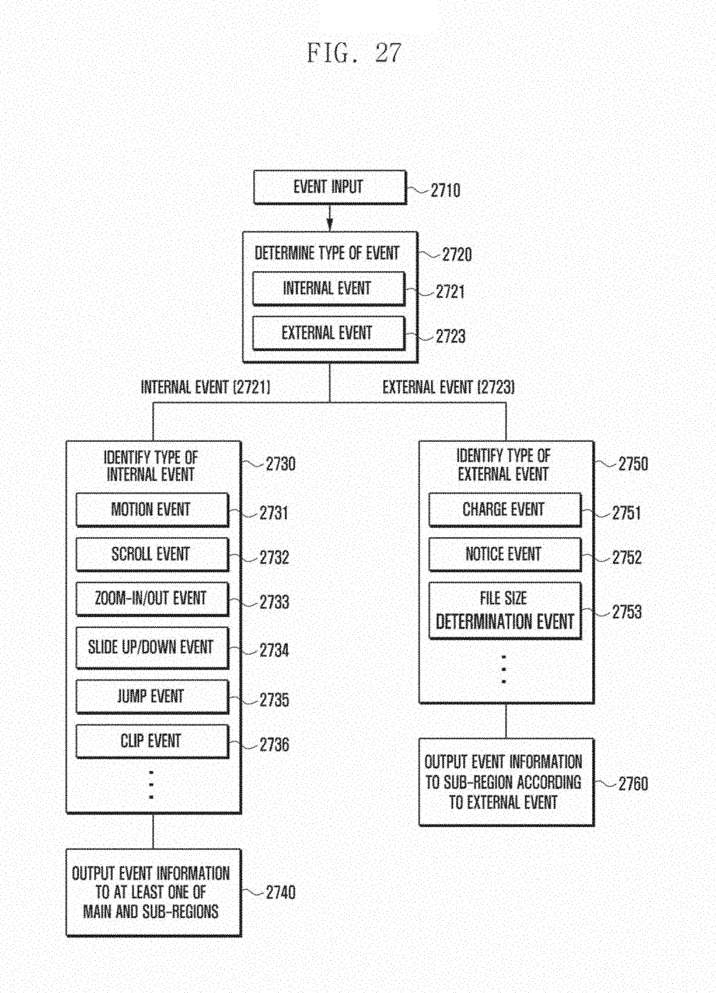

FIG. 27 is a diagram illustrating a method of operating functions using a bended display of a portable terminal according to an exemplary embodiment of the present invention.

Referring to FIG. 27, when an event input is received in step 2710, a controller 370 may determine a type of the input event in step 2720. For example, the controller 370 may determine whether the input event is an internal event 2721 or an external event 2723.

When the input event is the internal event 2721, the controller 370 identifies a type of the internal event in step 2730. For example, the controller 370 may determine whether the internal event 2721 is a motion event 2731, a scroll event 2732, a zoom-in/out event 2733, a slide up/down event 2734, a jump event 2735, or a clip event 2736.

The controller 370 may control output of event information corresponding to the input internal event 2721 to at least one of a main region 110 and a sub-region 120 of a bended display 100 in step 2740.

For example, when the internal event 2721 is the motion event 2731, the controller 370 may control display of a related screen through the main region 110 while controlling functions of the portable terminal according to a quick command in response to the input motion event 2731 through the sub-region 120 as in the example of an operation with reference to FIGS. 13 through 18.

If the internal event 2721 is the scroll event 2732, the controller 370 may control display of a related screen through the main region 110 while controlling the functions of the portable terminal according to a scroll command in response to the input scroll event 2732 through the sub-region 120.

If the internal event 2721 is the zoom-in/out event 2733, the controller 370 may control display of a related screen through the main region 110 while controlling the functions of the portable terminal according to a zoom-in command or a zoom-out command in response to the input zoom-in/out event 2733 through the sub-region 120.

If the internal event 2721 is the slide up/down event 2734, the controller 370 may control display of a related screen through the main region 110 while controlling the functions of the portable terminal according to a slide up command or a slide down command in response to the input slide up/down event 2734 through the sub-region 120.

When the internal event 2721 is the jump event 2735, the controller 370 may control display of a related screen through the main region 110 while controlling the functions of the portable terminal according to a jump command in response to the input jump event 2735 through the sub-region 120 as in the example of an operation with reference to FIGS. 10 through 12.

When the internal event 2721 is the clip event 2736, the controller 370 may control display of a related screen through the main region 110 or the sub-region 120 while controlling the functions of the portable terminal according to clipping or copying of a clip item in response to the clip event 2736 selected from the main region 110 and clipped on the sub-region 120 or the clip event 2736 selected from the sub-region 120 and copied to the main region 110 as in the example of an operation with reference to FIGS. 19 through 23.

If the input event is the external event 2723, the controller 370 identifies a type of the external event 2723 in step 2750. For example, the controller 370 may determine whether the external event 2723 is a charge event 2751, a notice event 2752, or a file size determination event 2753.

The controller 370 may control output of event information corresponding to the input external event 2723 to the sub-region 120 of the bended display 100 in step 2760.

For example, when the external event 2723 is the charge event 2751, the controller 370 may control display of a related screen through the sub-region 120 while charging a battery of the portable terminal in response to the charge event 2751, as in the example of an operation with reference to FIG. 9.

If the external event 2723 is the notice event 2752, the controller 370 may control display of a related screen corresponding to notice information, such as indicator information, pop-up information, push information, and the like, of the portable terminal through the sub-region 120 in response to the notice event 2752.

If the external event 2723 is the file size determination event 2753, the controller 370 may confirm a size of an attached file in response to the file size determination event 2753, and control display of a related screen through the sub-region 120, as in the example of an operation with reference to FIGS. 24 through 26.

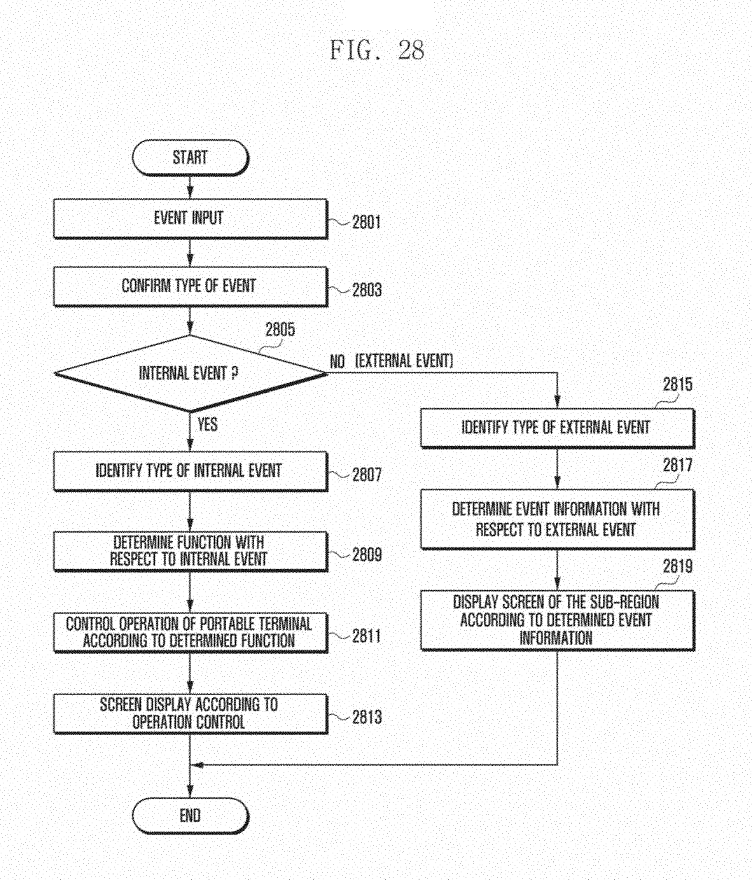

FIG. 28 is a flowchart illustrating a method of operating functions using a bended display of a portable terminal according to an exemplary embodiment of the present invention.

Referring to FIG. 28, if an event input is received in step 2801, a controller 370 confirms a type of the input event in step 2803, and may determine whether the input event is an internal event or an external event in step 2805.

If the input event is the internal event (YES of step 2805), the controller 370 identifies a type of the internal event in step 2807. For example, as described above, the controller 370 may determine whether the internal event is a motion event, a scroll event, a zoom-in/out event, a slide up/down event, a jump event, or a clip event.

If the type of the internal event is identified, the controller 370 determines a function with respect to the internal event in step 2809, and may control an operation of the portable terminal according to the determined function in step 2811. For example, the controller 370 determines a function corresponding to the input motion event, and may control an operation, such as release of a lock mode or execution of an application (e.g., a call function), of the portable terminal according to a quick command of the motion event. The controller 370 may determine a transition range corresponding to an input jump event, and control an operation of transitioning a contents screen of the portable terminal. The controller 370 may generate clip data corresponding to the input clip event and store the clip data in a clipboard or control an operation which copies clip data stored in the clipboard to an execution screen of the main region 110.

The controller 370 may control an operation of the portable terminal according to the internal event and control corresponding screen display in step 2813. For example, the controller 370 may control display of an operation control result of the portable terminal according to the internal event on one of the main region 110 and the sub-region 120. For example, the controller 370 may display a result screen according to the motion event on the main region 110, display a result screen according to the jump event on the main region 110, and display a result screen according to a clip event on at least one of the main region 110 and the sub-region 120. In a case of the clip event, a state that a clip item is clipped to the sub-region 120 may be displayed or a state that clip data of a clip item clipped to the sub-region 120 is incorporated into an execution screen of the main region 110 may be displayed.

If the input event is the external event (NO of step 2805), the controller 370 identifies a type of the external event in step 2815. For example, as described above, the controller 370 may determine whether the external event is a charge event, a notice event, or a file size determination event.

If the type of the external event is identified, the controller 370 determines event information with respect to the external event in step 2817, and may control screen display of the sub-region 120 according to the determined event information in step 2819. For example, the controller 370 may display charge information corresponding to a charge event on the sub-region 120, display notice information corresponding to a notice event on the sub-region 120, or display a size of the attached file corresponding to the file size determination event on the sub-region 120.

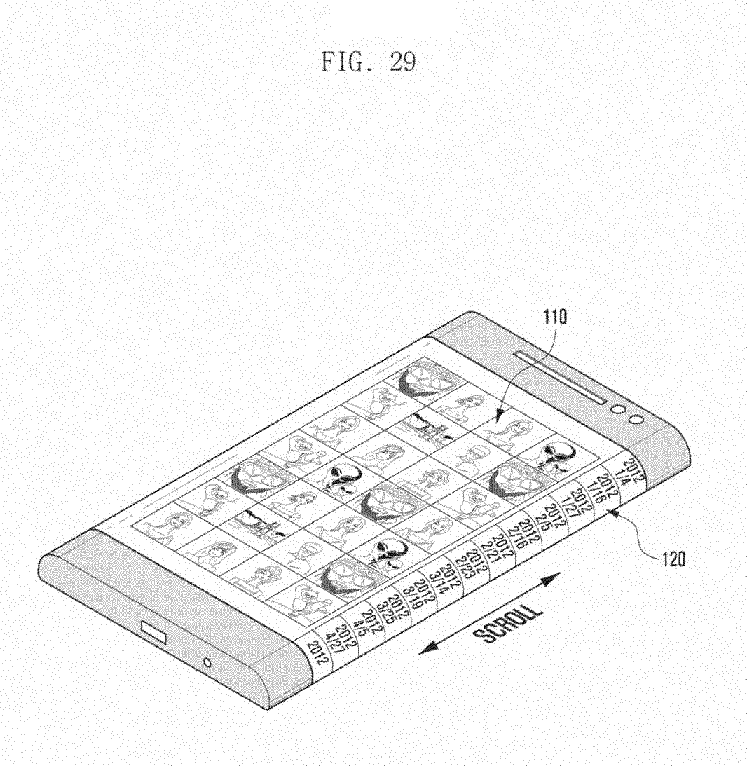

FIGS. 29 through 31 illustrate an operation using a bended display of a portable terminal according to an exemplary embodiment of the present invention.

Referring to FIGS. 29 through 31, a screen of the portable terminal illustrates that the portable terminal executes an application according to a user selection, and corresponding contents are provided through the main region 110 and the sub-region 120. For example, contents (e.g., a photograph list) corresponding to a user selection may be provided, and index (e.g., weather information, contact information (i.e., a user name) information, and the like) associated with the contents may be provided to the sub-region 120.

FIGS. 29 through 31 illustrate an operation which controls screen transition of the main region 110 using an input received through the sub-region 120 and input according to position variation of the portable terminal by a sensor (not shown). For example, FIGS. 29 through 31 illustrate an operation which displays information (i.e., scrolled information, filtered information, hidden information, and the like) with respect to an index touched through the sub-region 120 on the main region 110 when the user touches the sub-region 120 and tilts the portable terminal.

FIG. 29 illustrates a screen of a portable terminal wherein a user of the portable terminal executes a photograph application according to an exemplary embodiment of the present invention.

Referring to FIG. 29, contents of a photograph list may be displayed on the main region 110, and an index associated with the photograph list may be displayed on the sub-region 120. Date information (e.g., shot dates of the photograph data) extracted from respective photographs according to the photograph list or contact information (e.g., contact information which the user inputs with respect the respective photograph data) may be provided as an index of the sub-region 120. The index of the sub-region 120 may be scrolled in the sub-region 120 according to a user scroll event.

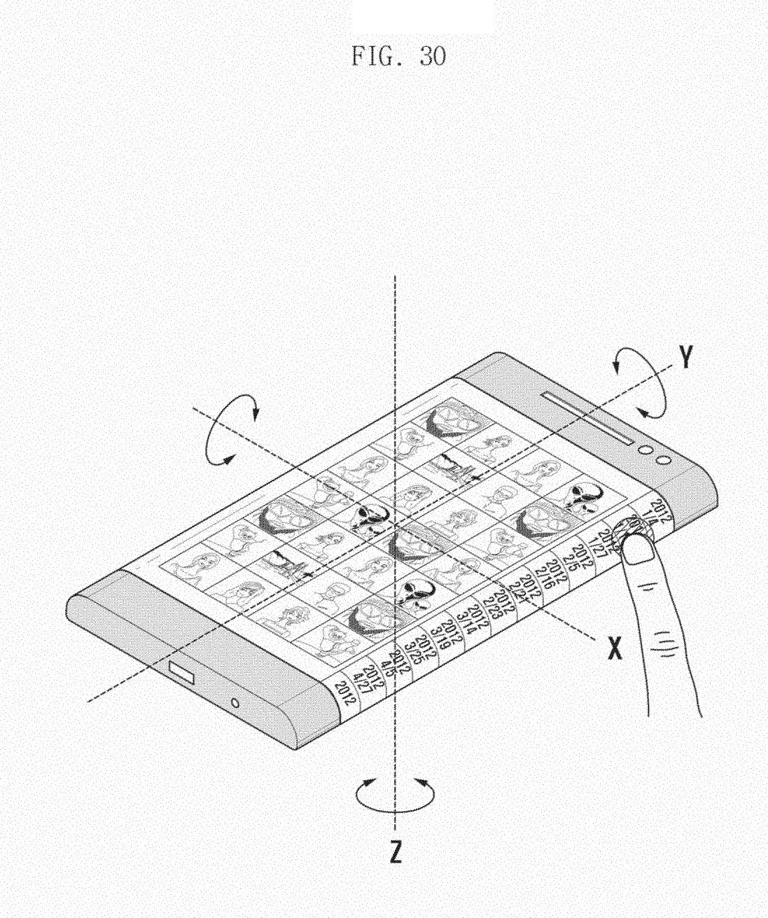

The user may input an interaction (e.g., a touch) by selecting an index (e.g., a specific date) part changing screen information of a photograph list of the main region 110 form the sub-region 120 as illustrated in FIG. 30. Furthermore, the user may input an interaction (e.g., tilting a portable terminal) while maintaining an input (e.g., a touch) by selecting a schedule index from the sub-region 120.

When a first interaction is input from the sub-region 120, the portable terminal may supply power to a sensor (e.g., a geomagnetic sensor, an acceleration sensor, and the like) for measuring the position of the portable terminal to detect a second interaction according to variation in the position of the portable terminal. Exemplary embodiments of the present invention may illustrate that an acceleration sensor (not shown) is used to detect the position of the portable terminal. Accordingly, the sensor may measure acceleration of the portable terminal to generate an electric signal, and transfer the electric signal to the controller 370. For example, assuming that the sensor is a 3 axis acceleration sensor, as shown in FIG. 30, the sensor may detect variation in a tilted position of the portable terminal based one at least one of an X axis, a Y axis, and a Z axis.

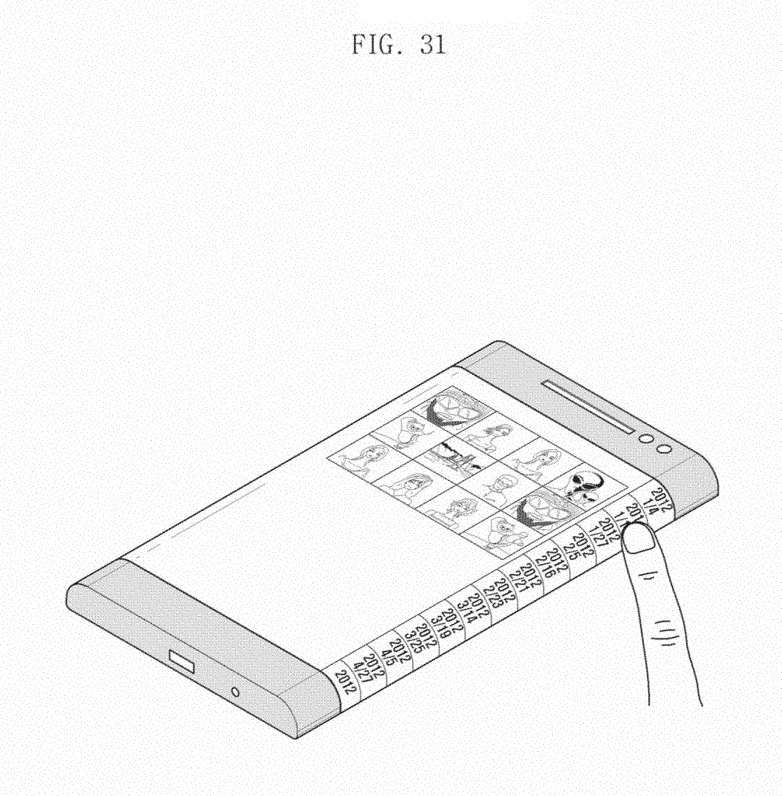

Referring to FIG. 30, if a second interaction based on the sensor is input in a state that input of a first interaction based on the sub-region 120 maintains, the portable terminal confirms an index corresponding to the first interaction, and extract information corresponding to the index. For example, the portable terminal may extract photograph data corresponding to an index (date) to which the first interaction is input from photograph data of a photograph list of the main region 110. If photograph data meeting the index are extracted, the portable terminal displays a screen as illustrated in FIG. 31. For example, a photograph list screen of the portable terminal shown in FIG. 30 may transition as illustrated in FIG. 31 according to inputs of the first interaction and the second interaction.

Referring to FIG. 31, the portable terminal may transition a screen to a photograph list screen with respect to photograph data meeting an index (date) to which the first interaction is input and displays the photograph list screen on the sub-region 120. For example, if a first interaction is input to a specific index of the sub-region 120 and a second interaction tilting the portable terminal is input, the portable terminal may filter information of the main region 110 based on a specific index to which the first interaction is input and represent the filtered information of the main region 110. For example, a screen configured based on information suited to the specific index is displayed on the main region 110.

An operation corresponding to FIGS. 29 through 31 is applicable to an electronic book application and a phone book application. For example, in a case of the electronic book application, a page index is provided to the sub-region 120. When the user selects an index of a specific page and tilts the portable terminal, a screen of the main region 110 may be represented by quickly scrolling the screen of the main region 110 to a corresponding page. In a case of a phone book application, a contact index is provided to the sub-region 120. When the user selects an index of a specific contact and tilts the portable terminal, a screen of the main region 110 may be represented by filtering only corresponding contact information.

The foregoing exemplary embodiments of the present invention may be implemented in an executable program command form by various computer means and be recorded in a computer readable recording medium. In this case, the computer readable recording medium may include a program command, a data file, and a data structure individually or in combination thereof. In the meantime, the program command recorded in a recording medium may be specially designed or configured for exemplary embodiments of the present invention or to be used by a person having ordinary skill in a computer software field. The computer readable recording medium includes a Magnetic Media, such as a hard disk, a floppy disk, or a magnetic tape, an Optical Media, such as a Compact Disc Read Only Memory (CD-ROM) or a Digital Versatile Disc (DVD), a Magneto-Optical Media, such as a floptical disk, and a hardware device, such as a ROM, a Random Access Memory (RAM), a flash memory for storing and executing program commands, and the like. Furthermore, the program command includes a machine language code created by a complier and a high-level language code executable by a computer using an interpreter. The foregoing hardware device may be configured to be operated as at least one software module to perform an exemplary operation of the present invention.

As mentioned above, according to the exemplary method of operating functions of a portable terminal having a bended display and the apparatus thereof of exemplary embodiments of the present invention, a display region of the portable terminal can be enlarged by extending a bended display having at least one bent end to a side of the portable terminal. According to exemplary embodiments of the present invention, the bended display is divided into a main region of a front surface and a sub-region of a side of the portable terminal, and function control of the portable terminal and function operation screen display can be supported using the sub-region. For example, the sub region can be used as a function region and a display region. Accordingly, exemplary embodiments of the present invention allow a user to approach information associated with a screen displayed on a main region of the front surface. Exemplary embodiments of the present invention can intuitively control functions of the portable terminal using the sub-region of the side of the portable terminal so that usability and operation of a user can be improved.

Exemplary embodiments of the present invention determine whether a part requiring control is included in a currently viewed screen through the main region. If the part requiring control is included in the currently viewed screen, the portable terminal can be easily and rapidly operated by inputting a touch event, a scroll event, a slide up/down event, and the like, using the sub-region. For example, a lock state can be released through a slide up or down operation using the sub-region, zoom-in/out can be controlled through a slide up or down operation using the sub-region in an image call mode, a shooting mode, an electronic book view mode, and the like, and a scroll event can be controlled through a scroll up or down operation using a sub-region in a browser. Setting information, such as screen brightness of the portable terminal or adjustment of loudness of voice, can be operated using the sub-region.

According to exemplary embodiments of the present invention, important information can be efficiently provided to the user according to a state of the portable terminal. For example, when a charger is mounted, a current battery charge level is provided through the sub-region, message reception notice, such as a portable terminal lock state, a game state, a moving image viewing state, and the like, is received when using the main region as a total screen, and pop-up can be provided through the sub-region. Accordingly, the user can directly confirm efficiently received information without interfering with a screen displayed on the main region.

Exemplary embodiments of the present invention can be implemented by various types of portable terminals and various corresponding devices. According to exemplary embodiments of the present invention, usability, convenience, and competitive force of the portable terminal can be improved by implementing an optimal environment for controlling and displaying functions of the portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An electronic apparatus comprising:
a touch display configured to comprise a main display area and an auxiliary display area, the auxiliary display area comprising a curved portion extended from the main display area; and
at least one processor configured to:
control the touch display to display an information on the main display area and to display a user interface (UI) corresponding to the information displayed on the main display area, on the auxiliary display area,
receive a drag input which comprises touching the UI, continuously moving a touch point which touches the UI from the auxiliary display area to the main display area and releasing the touch point on the main display area, and
control the touch display to display another information on the main display area in response to receiving the drag input.

2. The apparatus of claim 1, wherein the at least one processor is further configured to change the information provided on the main display area according to a touch input to the UI.

3. The apparatus of claim 1,
wherein the information provided on the main display area comprises a lock screen,
wherein the UI comprises a lock release UI to release the lock screen, and
wherein the at least one processor, in response to receiving a touch input to the lock release UI, is further configured to control the touch display to convert the lock screen to a home screen and provide the home screen on the main display area.

4. A controlling method of an electronic apparatus with a touch display configured to comprise a main display area and a curved auxiliary display area which extends from the main display area in an integrated manner to bend towards one side of the main display area, the curved auxiliary display area being smaller than the main display area, the method comprising:
providing information on the main display area, and providing a user interface (UI) corresponding to the information displayed on the main display area, on the curved auxiliary display area;
receiving a drag input which comprises touching the UI, continuously moving a touch point which touches the UI from the auxiliary display area to the main display area and releasing the touch point on the main display area, and
controlling the touch display to display another information on the main display area in response to receiving the drag input.

5. The method of claim 4, wherein the controlling of the information provided on the main display area comprises changing the information provided on the main display area according to a touch input to the UI.

6. The method of claim 4,
wherein the information provided on the main display area comprises a lock screen,
wherein the UI comprises a lock release UI to release the lock screen, and
wherein the controlling comprises, in response to receiving a touch input to the lock release UI, converting the lock screen to a home screen and providing the home screen on the main display area.

7. An electronic apparatus comprising:
a display configured to comprise a main display area and a curved auxiliary display area which extends from the main display area in an integrated manner to bend towards one side of the main display area, the curved auxiliary display area being smaller than the main display area; and
at least one processor configured to control the display to:
display a first screen on the main display area,
display a second screen related to the first screen on the curved auxiliary display area,
receive a drag input which comprises touching the second screen, continuously moving a touch point which touches the second screen from the curved auxiliary display area to the main display area and releasing the touch point on the main display area, and
change the first screen in response to receiving the drag input.

8. The apparatus of claim 7,
wherein the first screen comprises a lock screen,
wherein the second screen comprises a lock release UI to release the lock release screen, and
wherein the at least one processor, in response to receiving a user input to the lock release UI, is further configured to control the display to convert the lock screen to a home screen and display the home screen on the main display area.

9. The apparatus of claim 7, wherein the at least one processor, in response to occurrence of an event, is further configured to control the display to provide information regarding a recharging state of the electronic apparatus on the curved auxiliary display area.

10. A controlling method of an electronic apparatus with a display configured to comprise a main display area and a curved auxiliary display area which extends from the main display area in an integrated manner to bend towards one side of the main display area, the curved auxiliary display area being smaller than the main display area, the method comprising:
displaying a first screen on the main display area and displaying a second screen related to the first screen on the curved auxiliary display area;
receiving a drag input which comprises touching the second screen, continuously moving a touch point which touches the second screen from the curved auxiliary display area to main display area and releasing the touch point on the main display area; and
changing the first screen in response to receiving the drag input.

11. The method of claim 10,
wherein the first screen comprises a lock screen,
wherein the second screen comprises a lock release UI to release the lock release screen, and
wherein the controlling of the first screen comprises, in response to receiving a user input to the lock release UI, converting the lock screen to a home screen and displaying the home screen on the main display area.

12. The method of claim 10, wherein the controlling of the first screen comprises, in response to occurrence of an event, providing information regarding a recharging state of the electronic apparatus on the curved auxiliary display area.
